(19) United States
(12) Patent Application Publication
(10) Pub. No.: US 2016/0132778 A1
(43) Pub. Date: May 12, 2016

(54) SIMULATION APPARATUS, METHOD FOR THE SAME, AND PROGRAM

(71) Applicant: Kabushiki Kaisha Toshiba, Minato-ku (JP)

(72) Inventor: Hisashi HAYASHI, Yokohama (JP)

(73) Assignee: Kabushiki Kaisha Toshiba, Minato-ku (JP)

(21) Appl. No.: 14/995,299

(22) Filed: Jan. 14, 2016

Related U.S. Application Data
(63) Continuation of application No. PCT/JP2014/068912, filed on Jul. 16, 2014.

(30) Foreign Application Priority Data
Jul. 16, 2013 (JP) 2013-147996

(51) Int. Cl. G06N 5/04; G06F 17/50

(52) U.S. Cl. CPC G06N 5/045; G06F 17/5009

(57) ABSTRACT

A simulation apparatus according to one embodiment, including: an event receiver, a decision maker and an execution command transmitter. The event receiver receives an event showing a situation of a first monitor target simulated by a first simulator simulating at least one of motion and state change of the first monitor target from a monitor apparatus monitoring a simulation of the first simulator. The decision maker determines an action based on the event, the action to be carried out with respect to a second monitor target undergoing a simulation of at least one of motion and state change by a second simulator synchronized with the first simulator by time progress. The execution command transmitter transmits an execution command of the action determined by the decision maker to a control apparatus controlling the second simulator.

### CROSS REFERENCE TO RELATED APPLICATIONS

This application is a Continuation of International Application No. PCT/JP2014/068912, filed on Jul. 16, 2014, the entire contents of which is hereby incorporated by reference.

### FIELD

An embodiment of the present invention relates to a simulation apparatus, a method for the same, and a program.

### BACKGROUND

Conventionally, there has been a simulation apparatus which carries out simulations respectively in fields by independently using simulators (field-specific simulators) specialized in the fields such as traffic, electric power, water and sewage, gas, heat, medical services, and education. Moreover, there has been a simulation apparatus which comprehensively simulates the results of individual actions carried out by a plurality of humans (agents) by the decisions of themselves.

Meanwhile, in order to design/evaluate smart communities, etc., development of a simulation apparatus which carries out simulations across a plurality of different fields, particularly, a simulator apparatus which comprehensively simulates the results of actions carried out by one or a plurality of humans (agents) in a plurality of different fields is desired.

### BRIEF DESCRIPTION OF THE DRAWINGS

FIG. 1 is a block diagram of a meta-level multi-agent simulator according to an embodiment of the present invention;

FIG. 2 is a flow chart showing an example of operation of a simulation controller of the meta-level multi-agent simulator according to the embodiment of the present invention;

FIG. 3 is a flow chart showing an example of operation of an agent of the meta-level multi-agent simulator according to the embodiment of the present invention;

FIG. 4 is a flow chart of a specific example of operation of “step 2” shown in FIG. 3;

FIG. 5 is a drawing showing an example of a report-interval DB with respect to probe car agents according to Example 1;

FIG. 6 is a drawing showing an example of a simulator control-rule DB of the probe car agents according to Example 1;

FIG. 7 is a drawing showing an example of environment reference in an execution command transmitter of the probe car agent according to Example 1;

FIG. 8 shows drawings showing the state of update of the report-interval DB according to Example 1;

FIG. 9 is a drawing showing an example of a report-interval DB according to Example 2;

FIG. 10 is a drawing showing an example of a simulator control-rule DB according to Example 2;

FIG. 11 is a drawing showing an example of a belief DB according to Example 2;

FIG. 12 is a drawing showing the state of update of the report-interval DB according to Example 2;

FIG. 13 is a drawing showing an example of a report-interval DB according to a traffic simulator according to Example 3;

FIG. 14 is a drawing showing an example of a simulator control-rule DB in an EV agent according to Example 3;

FIG. 15 is a drawing showing an example of an environment reference DB in the EV agent according to Example 3;

FIG. 16 is a drawing showing an example of the report-interval DB for a charge station simulator according to Example 3;

FIG. 17 is a drawing showing an example of a simulator control-rule DB of a charge station agent according to Example 3;

FIG. 18 is a drawing showing an example of an environment DB according to Example 3;

FIG. 19 is a drawing showing the state of update of the report-interval DB of the charge station simulator according to Example 3;

FIG. 20 is a drawing showing an example of a report-interval DB for an electric-power consumer according to Example 4;

FIG. 21 is a drawing showing an example of a simulator control-rule DB of an electric-power consumer agent according to Example 4;

FIG. 22 is a drawing showing an example of an environment reference DB of the electric-power consumer agent according to Example 4;

FIG. 23 is a drawing showing an example of a report-interval DB for an electric-power supplier agent according to Example 4;

FIG. 24 is a drawing showing an example of a simulator control-rule DB of the electric-power supplier agent according to Example 4;

FIG. 25 is a drawing showing an example of an environment reference DB of the electric-power supplier agent according to Example 4;

FIG. 26 is a drawing showing an example of a simulator control-rule DB of an EV agent according to Example 5;

FIG. 27 is a drawing showing an example of a report-interval DB of the EV agent according to Example 5;

FIG. 28 is a drawing showing an environment reference DB of the EV agent according to Example 5;

FIG. 29 is a drawing showing the state of update of the report-interval DB according to Example 5;

FIG. 30 is a drawing showing a specific example of field-specific simulators and agents according to Example 1;

FIG. 31 is a drawing showing a specific example of field-specific simulators and agents according to Example 3;

FIG. 32 is a drawing showing a specific example of field-specific simulators and agents according to Example 4;

FIG. 33 is a drawing showing a specific example of a field-specific simulator and agents according to Example 5;

FIG. 34 is a hardware configuration diagram of the meta-level multi-agent simulator shown in FIG. 1; and

FIGS. 35A, 35B and 35C show block diagrams of a modification example of the meta-level multi-agent simulator according to the embodiment of the present invention.

### DETAILED DESCRIPTION

A simulation apparatus according to one embodiment, including: an event receiver, a decision maker and an execution command transmitter. The event receiver receives an event showing a situation of a first monitor target simulated by a first simulator simulating at least one of motion and state change of the first monitor target from a monitor apparatus monitoring a simulation of the first simulator. The decision maker determines an action based on the event, the action to be carried out with respect to a second monitor target undergoing a simulation of at least one of motion and state change by a second simulator synchronized with the first simulator by time progress. The execution command transmitter transmits an execution command of the action determined by the decision maker to a control apparatus controlling the second simulator.

Hereinafter, an embodiment of the present invention will be explained with reference to drawings.

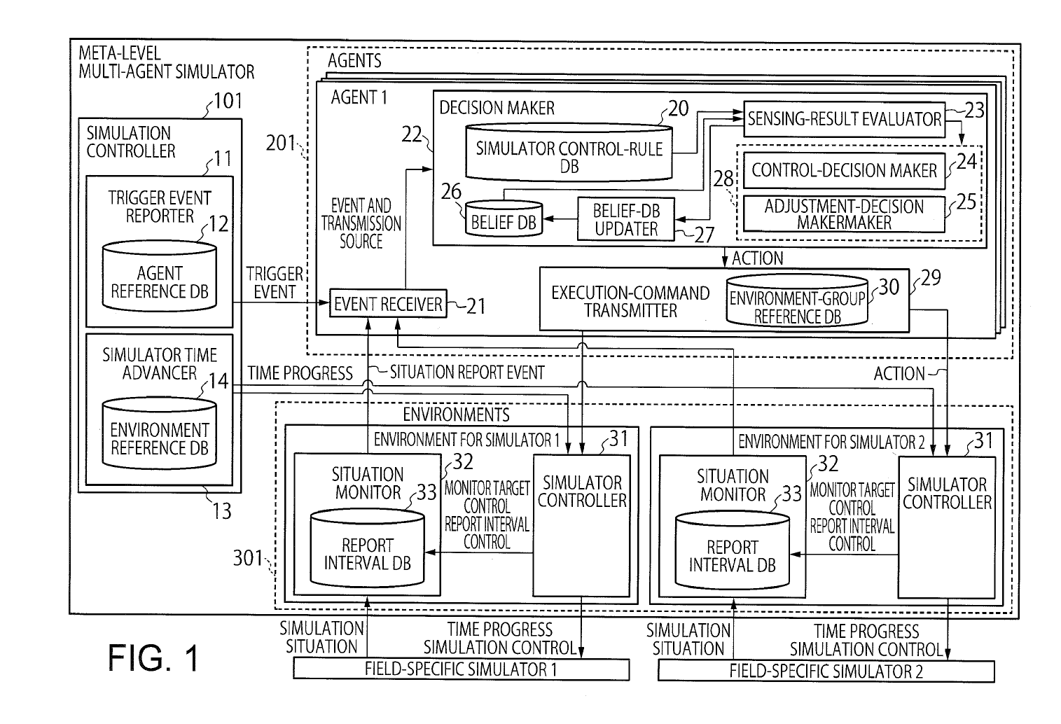

FIG. 1 is a block diagram of a metal-level multi-agent simulator as a simulator apparatus according to the embodiment of the present invention.

The meta-level multi-agent simulator is provided with a simulation controller 101, a plurality of environments for simulators, and one or a plurality of agents. Herein, two environments, i.e., an environment for a simulator 1 and an environment for a simulator 2 are provided. However, three or more environments may be provided.

The field-specific simulators 1 and 2 are communicatably connected to the environments for the simulators 1 and 2, respectively. Examples of the field-specific simulators include traffic simulators and electric-power simulators.

In the field-specific simulator, at least one of motions and state changes of one or a plurality of monitor targets is executed in a simulated manner. As examples of the motions, if the monitor target is a vehicle, movements/actions of the vehicle are included. If the vehicle is an automobile, movements (position, velocity, acceleration rate, drive direction, etc.) and actions (for example, light-up of lights, opening/closing of side mirrors) of the automobile, which drives on a road, are included; and, in a case of an elevator, upward/downward movements and actions (opening/closing of a door, etc.) of the elevator are included. If the state of the monitor target can be expressed by parameters, examples of the state changes include variations in the parameters of the monitor target. If the monitor target is electric-power consumption equipment, variations in the voltage, current, and electric power of the equipment are included; if the monitor target is a stock exchange system such as a stock exchange, description of securities and stock price volatilities such as stock indexes are included; in a case of a currency exchange system of a financial institution or the like, rate variations in currency pairs (USD/JPY, etc.) are included; and, in a case of a provider which provides products and services, variations in the prices and contents of the products and services provided by the provider are included. As an example of simulating both of the motions and the state changes, there is a case in which both of the motions such as the position, velocity, etc. of an automobile(s) and variations in parameters such as a remaining energy amount(s) are simulated. The monitor targets may include not only apparatuses such as automobiles and electric-power consumption equipment, but also living objects such as humans and animals.

The meta-level multi-agent simulator advances simulations of the field-specific simulators 1 and 2 while synchronizing time progress and reflects at least one of motions and state changes of the monitor target(s) of at least one of the field-specific simulators 1 and 2 to at least one of the motions and state of the monitor target(s) of at least the other one of the field-specific simulators 1 and 2 by using the above described agents, thereby carrying out simulations across the field-specific simulators 1 and 2. As an example, in the meta-level agent simulator, the above described agents are prepared respectively for the simulated monitor targets, thereby comprehensively simulating the results of actions carried out by one or a plurality of humans (agents) in a plurality of different fields.

Each of the environments for the simulators 1 and 2 is provided with a simulator controller (simply referred to as a controller in some cases) 31 and a situation monitor 32. The situation monitor 32 includes an agent/event-corresponding report-interval database (DB) 33.

The situation monitor 32 monitors the simulations executed by the field-specific simulator, which is connected thereto.

The agent/event-corresponding report-interval DB 33 stores detected events, report-destination agents, and report time intervals separately for each of monitor targets, which are monitored by the field-specific simulator, or separately for each of the agents. The event is for reporting the situation of the monitor target corresponding to the type of the event to the report-destination agent. The situation may specify a motion or a state of the monitor target, may be a higher-level action state estimated from the motion or the state, or may express an environment of the monitor target. Examples of the situation include, if the monitor target is a vehicle, values such as the position and velocity thereof, the number of vehicles around the vehicle, and weather information of the location of the vehicle. An example of the higher-level action state may be an action state such as “moving toward a charge stand” in a case in which movement toward the charge stand is estimated when remaining energy of an automobile is equal to or less than a certain value. If the monitor target is electric-power consumption equipment, values such as consumed electric power, voltages, and currents are also conceivable. In a typical example, a configuration in which the event detected from the monitor target is reported to the agent corresponding to the monitor target is conceivable; however, a configuration in which it is reported to another agent is also possible.

The situation monitor 32 generates events at the report time intervals determined by the report-interval DB 33 based on monitoring of the simulations of the field-specific simulators and transmits the events to event receivers 21 of the report-destination agents.

The simulator controller 31 controls the time progress of the corresponding field-specific simulator in response to instruction signals from a later-described simulator time advancer 13 and controls the corresponding field-specific simulator in accordance with commands to execute control actions received from the agent. Moreover, the simulator controller 31 updates the report-interval DB 33 in accordance with commands to execute adjustment actions received from the agent. As examples of the update, the detected events, the report-destination agents of the events, or the report time intervals of the events are changed in some cases.

The simulation controller 101 has a role to advance the simulation time in the field-specific simulators. The simulation controller 101 is provided with a trigger event reporter 11 and the simulator time advancer 13.

The trigger event reporter 11 has a role to periodically urge the agents to make decisions. The event reporter 11 has an agent reference DB 12. In the agent reference DB 12, identification information of the agents and event report intervals of each of the agents are stored. The trigger event reporter 11 periodically transmits trigger events to urge decision-making to the event receivers 21 of the agents, which are registered in the agent reference DB 12, at the event report intervals registered in the DB. Note that, in the agent which has received the trigger event(s), the number of times of receiving the trigger event(s) is recorded, a decision to carry out an action determined in advance is made depending on the number of times of reception, and an execution command of the action is transmitted to the simulator controller 31. Note that the simulation controller 101 may be configured not to be provided with the trigger event reporter 11. Also in this case, the agents make decisions in accordance with the events received from the environments for the simulators 1 and 2.

The simulator time advancer 13 has a role to synchronize the simulation time progress of the field-specific simulators. The simulator time advancer 13 has an environment reference DB 14. In the environment reference DB 14, information of the plurality of environments for simulators is registered. The simulator time advancer 13 outputs a signal (instruction signal) which instructs to advance the simulation time of the corresponding field-specific simulator by certain time Δt to each of the environments for the simulators registered in the environment reference DB 14. Each of the simulator environments receives the instruction signal(s) from the simulator time advancer 13. The simulator controller 31 of the environment for the simulator which has received the instruction signal controls the field-specific simulator so as to advance the simulation time by Δt. “At” is the same value among the environments for the simulators. Note that the actual time required for advancing the simulation time by Δt may be different in each field-specific simulator.

Herein, the simulator time advancer 13 may output the instruction signals, which advance the time by the certain time Δt, simultaneously to the environments for the simulators, wait until the simulation time of all the field-specific simulators is advanced by Δt, and then output the next instruction signals to advance the time by the certain time Δt. Alternatively, the instruction signals, which advance the time by the certain time Δt, may be output in order one at a time to the environments for the simulators sequentially every time the process for the single field-specific simulator is completed. The simulator time advancer 13 may confirm that the simulation time has been advanced by the certain time Δt by receiving response confirmation signals from the environments for the simulators.

Each of the agents of the meta-level multi-agent simulator is provided with the event receiver 21, a decision maker 22, and an execution command transmitter 29.

The event receiver 21 receives events reported from outside. The outside is the situation monitors 32 of the environments for the simulators and the trigger event reporter 11. Note that, if the trigger event reporter 11 is not provided, the event receiver 21 receives the events from the situation monitor 32.

The decision maker 22 is provided with a simulator control-rule DB 20, a sensing-result evaluator 23, a belief DB 26, a belief-DB updater 27, and a decision-making processor 28. The decision-making processor 28 is provided with a control-decision maker 24 and an adjustment-decision maker 25.

The decision maker 22 has a role to make a decision to execute a corresponding action by being triggered by the event received by the event receiver 21 and carrying out rule base inference based on a control rule(s), which is stored in the simulator control-rule DB 20, and transmit the execution command of the action to the environment for the simulator. The simulator controller 31 of the environment for the simulator, which has received the execution command of the action, controls the field-specific simulator in accordance with the execution command of the action. For example, in accordance with the contents of the action, the motion or state of the monitor target(s) of the corresponding simulator is controlled. One of the characteristics of the present embodiment resides in a point that not only the case in which the environment for the simulator which has reported the event to the agent and the environment for the simulator which receives the execution command of the action because of the event report are the same, but also the case in which the environments are different from each other are provided. As a result, a simulation(s) across a plurality of fields is enabled. Also, a comprehensive simulation(s) of the results of actions carried out by monitor targets (or agents) such as humans in a plurality of different fields is enabled.

The simulator control-rule DB 20 stores one or a plurality of control rules. In the control rules, events, conditions, and actions are defined. Reception of the event shown in the control rule and satisfaction of the condition of the control rule are referred to that the control rule is fired. The event and the condition for firing the control rule are collectively referred to as fire conditions. More specifically, if the event shown in the control rule is received and the condition of the control rule is satisfied, it is referred to that the fire condition is satisfied or the control rule is fired. Note that a configuration in which the condition is omitted in the control rule can be also used; and, in that case, if the event selected by the control rule is received, the fire condition of the control rule is satisfied.

The control rules can be described by arbitrary format such as an “If-then” format and an “If-when-then” format. For example, in the “if-then” format, when an event and an action are described in “if” and “then”, respectively, it can be expressed that, if the event defined in “if” is received, execution of the action described in “then” is determined. Also, in the “if-when-then” format, when an event, a condition, and an action are described in “if”, in “when”, and in “then”, respectively, it can be expressed that, if the event defined in “if” is received and the condition defined in “when” is satisfied, execution of the action described in “then” can be determined.

The conditions for determining execution of actions can be described by using, for example, parameters (values) of the events (values of sensing data showing the situation of monitor targets) and predetermined calculation expressions using the parameters of the events. As the parameters of the events, the parameters of not only the events received this time, but also the events received in the past can be also used.

Based on at least the former one of the event reported from outside and the belief DB 26 (described later), the sensing-result evaluator 23 evaluates if the fire conditions of the control rules stored in the simulator control-rule DB 20 are satisfied. More specifically, the control rule is selected depending on the event reported from outside, and whether the condition described in the selected control rule is satisfied or not is judged. The conditions described in the control rules are various, and, depending on the contents of the condition, whether the condition is satisfied or not is judged by calculating a predetermined calculation expression by using, for example, the value of an event or the value of an event received in the past. The belief DB 26 is used for storing the values of the events received in the past and the results calculated in the past.

In the belief DB 26, the information necessary for calculating whether the conditions such as the values of the events reported from outside in the past are satisfied is stored. The belief DB 26 is updated by the belief-DB updater 27. The belief-DB updater 27 updates the belief DB 26 in accordance with instruction signals of the sensing-result evaluator 23. In a case of a configuration in which only the value(s) of the event reported this time is used for judging whether the condition is satisfied or not without using the value(s) of the event(s) reported in the past, a configuration in which the belief DB 26 and the belief-DB updater 27 are not used is also possible.

If the control rule that has been judged to satisfy the fire condition is present, the sensing-result evaluator 23 activates the decision-making processor 28, and, if update of the belief DB 26 is required, activates the belief-DB updater 27. If the control rule that satisfies the fire condition is not present, a configuration in which only the belief-DB update is activated and a configuration in which nothing is carried out are conceivable.

If the conditions of the control rules include usage of the values of the events received in the past (for example, previous time), the sensing-result evaluator 23 outputs an instruction signal to the belief-DB updater 27 so as to store the value of the event received this time in the belief DB 26 so that they can be used in the next process. The belief-DB updater 27 updates the belief DB 26 in accordance with the instruction signal of the sensing-result evaluator 23. Data such as old data of a certain period or more ago which is not used in the process in the sensing-result evaluator 23 may be erased.

The decision-making processor 28 reads the action which is defined in the control rule, which has been judged to satisfy the fire condition by the sensing-result evaluator 23, and makes a decision to execute the action. The actions include actions (control actions) to control the field-specific simulators and actions (adjustment actions) to adjust the frequency of detecting the types/events of the events serving as the monitor targets of the field-specific simulators. The adjustment actions may include actions to change the monitor targets.

If the read action is a control action, the decision-making processor 28 makes a decision in the control-decision maker 24 to execute the control action; and, if it is an adjustment action, the decision-making processor 28 makes a decision in the adjustment-decision maker 25 to execute the adjustment action.

The execution command transmitter 29 references the environment reference DB 30 to determine the environment for the simulator which serves as a report destination of the action determined by the decision-making processor 28 and transmits an execution command of the action to the determined report destination. The environment reference DB 30 stores identifiers of the field-specific simulators respectively for the actions. The execution command transmitter 29 specifies the field-specific simulator corresponding to the action determined by the decision-making processor 28 and transmits an execution command of the action to the environment for the simulator connected to the specified field-specific simulator.

The controller of the environment for the simulator which has received the execution command of the control action as an action controls the field-specific simulator in accordance with the execution command of the control action. For example, the monitor target(s) simulated by the simulator is caused to undergo motion or state change in accordance with the control action. Moreover, the controller of the environment for the simulator which has received the execution command of the adjustment action as an action outputs an instruction signal to change, for example, the sensing frequency (detection frequency) of the type of the event(s) or the event(s) serving as a monitor target(s), and the situation monitor 32 updates the report-interval DB 33 in accordance with the instruction signal.

If a trigger event is received from the trigger event reporter 11, the decision maker 22 references the simulator control-rule DB 20 and selects the control rule which satisfies the fire condition by the sensing-result evaluator 23. In the condition of the control rule, for example, a condition about the total number of times of reception of trigger events may be described. In this case, the sensing-result evaluator 23 updates the total number of reception by reading the number of times of reception until the previous time and incrementing it and writes the updated value again in the belief DB 26. If the total number of reception satisfies the condition, the sensing-result evaluator 23 reports the control rule in which the fire condition is satisfied to the decision-making processor 28, and the decision-making processor 28 makes a decision to execute the action described in the control rule. The execution command transmitter 29 references the environment reference DB 30 to determine the environment which serves as a report destination of the execution command of the action and transmits an execution command of the action to the determined environment. A particular action may be an action that causes a monitor target corresponding to the agent to carry out particular motion or state change, may be an action that detects a particular event from the monitor target, or may be another action. As a modification example, a configuration in which the control rule is not used is also possible. For example, when trigger events are received, the decision maker 22 may be configured to count the total number of reception, determine an action determined in advance every time the total number of reception is increased by a certain value, and transmit an execution command of the action to the environment determined in advance. The action determined in advance may be a control action or an adjustment action. The environment determined in advance may be the environment for simulations which simulates the monitor target(s) corresponding to the agent or may be a different environment.

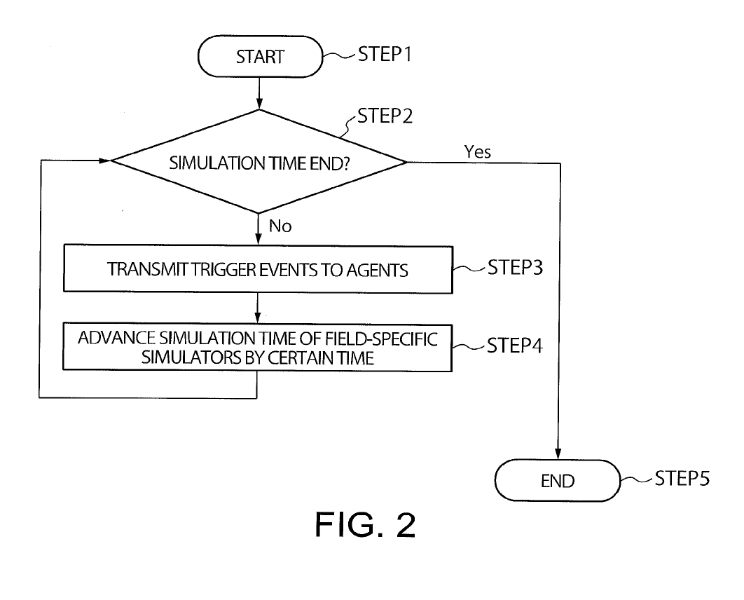

FIG. 2 shows a flow chart of operation of the simulation controller 101 in the meta-level multi-agent simulator.

After start (step 1), whether the simulation time determined in advance has been ended or not is judged (step 2), and, if ended (yes of step 2), the operation is ended (step 5). If not (no of step 2), the trigger event reporter 11 transmits trigger events to the agents in accordance with the agent reference DB 12 (step 3).

Then, the simulator time advancer 13 transmits instruction signals to the environments for the simulators so as to advance the simulation time of the field-specific simulators by the certain time Δt (step 4). When advance of the simulation time of all the field-specific simulators by Δt is confirmed, the process returns to step 2.

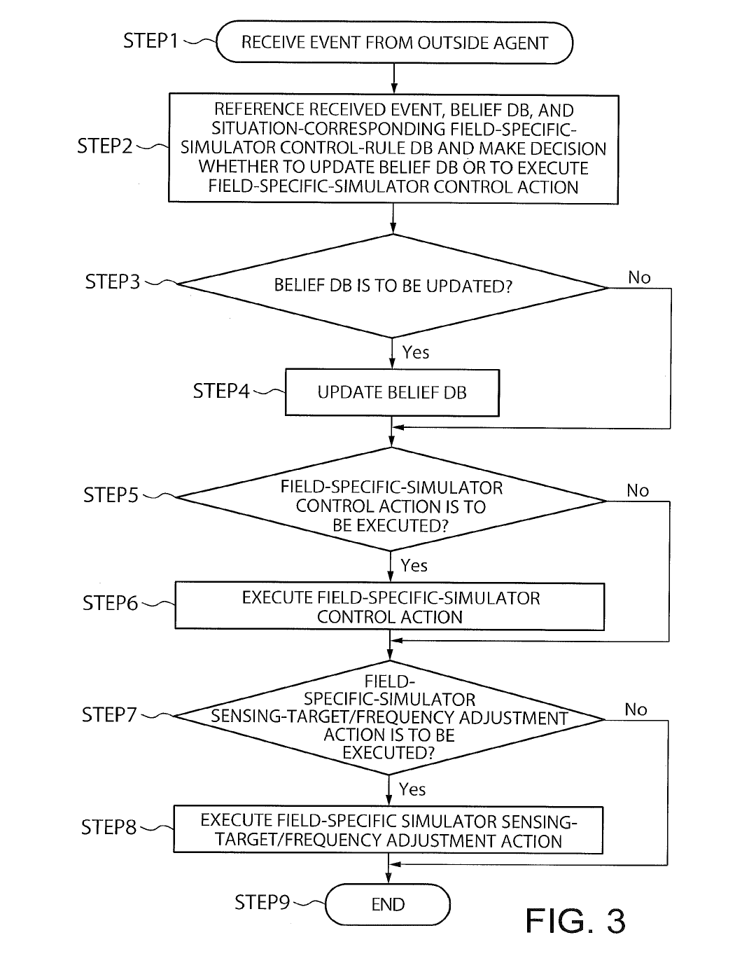

FIG. 3 shows a flow chart of the agent in the meta-level multi-agent simulator. Herein, the flow chart of the operation carried out particularly when the agent receives an event from outside is shown.

When the agent receives an event from outside (step 1), the process proceeds to step 2. The sensing-result evaluator 23 references the received event, the belief DB 26, and the simulator control-rule DB 20 and evaluates whether the control rule in which the fire condition is satisfied is present. If the control rule in which the fire condition is satisfied is present, in accordance with the action described in the control rule, the decision-making processor 28 makes a decision to execute a control action, makes a decision to execute an adjustment action, or determines both of them. Moreover, the sensing-result evaluator 23 judges whether to update the belief DB 26.

If the sensing-result evaluator 23 judges in step 1 that the belief DB 26 is to be updated (yes of step 3), the belief-DB updater 27 updates the belief DB 26 (step 4), and the process proceeds to step 5. If not (no of step 3), the process proceeds to step 5 without updating the belief DB 26.

In step 5, whether the decision to execute the control action has been made in step 1 is judged, and, if the decision of execution has been made (yes of step 5), the process proceeds to step 6. In step 6, the execution command transmitter 29 references the environment reference DB 30 to determine the environment that serves as a report destination of an execution command of the control action and reports the execution command of the action to the determined report destination. Then, the process proceeds to step 7. On the other hand, if the decision to execute the control action has not been made (no of step 5), the process directly proceeds to step 7.

In step 7, whether the decision to execute the adjustment action has been made in step 1 is judged, and, if the decision of execution has been made (yes of step 7), the process proceeds to step 8. In step 8, the execution command transmitter 29 references the environment reference DB 30 to determine the environment serving as a report destination of an execution command of the adjustment action and reports the execution command of the action to the determined report destination. Then, the operation is ended (step 9). On the other hand, if the decision to execute the adjustment action has not been made in step 1 (no of step 7), the process is directly ended (step 9).

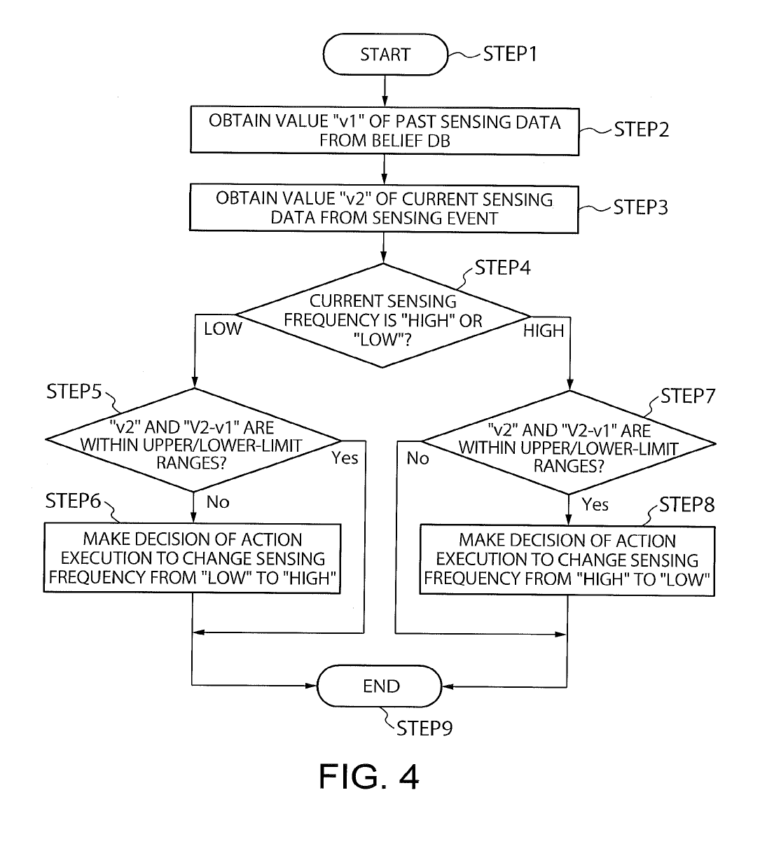

As a specific example of the operation of step 2 shown in FIG. 3, FIG. 4 shows a flow chart of the process from satisfaction of the fire condition of a particular control rule until the decision to execute an adjustment action of the sensing frequency is made. Note that, in this case, an event has been received, an example of the process from the point of time to judge whether the condition of the control rule showing the event is satisfied is shown. It is assumed that, in the control rule, two conditions are selectively described, and actions to be subjected to decision-making of execution in a case of satisfaction thereof are described respectively for the conditions.

After start (step 1), a value (value of event) “v1” of past sensing data is acquired from the belief DB 26 (step 2), and a value v2 of sensing data is acquired from the event received this time by the event receiver 21 (step 3). The past sensing data is sensing data included in an event which has been received a certain times before such as one time before.

Whether the current sensing frequency is high or low is judged. It is judged to be high in a case of a certain value or more and judged to be low in a case of less than the certain value. The current sensing frequency is acquired by reading from the belief DB 26. If the current sensing frequency is judged to be low (“low” of step 4), whether the value “v2” and “v2−v1” (“−” is subtraction) are within predetermined upper/lower-limit ranges is judged (step 5). Note that, as the upper/lower-limit ranges, mutually different upper/lower-limit ranges are used for the values “v2” and “v2−v1”, respectively.

If both of the values “v2” and “v2−v1” are within the upper/lower-limit ranges (yes of step 5), the process is directly ended (step 9). In other words, this case is a case in which one of the conditions described in the control rule is not satisfied.

On the other hand, if at least one of “v2” and “v2−v1” is not within the upper/lower-limit ranges (no of step 5), a decision of action execution to change the sensing frequency from “low” to “high” is made (step 6), and the process is ended (step 9). Therefore, this case corresponds to a case in which the above described one of the conditions described in the control rule is satisfied, and a decision to execute an action of changing the sensing frequency to “high” as the action determined in accordance with the condition is made. It is assumed that “high” is a predetermined value and is a value higher than a threshold value judged in step 4.

If it is judged that the current sensing frequency is high (“high” of step 4), whether “v2” and “v2−v1” are respectively within the upper/lower-limit ranges is judged (step 7). On the other hand, if at least one of “v2” and “v2−v1” is not within the upper/lower-limit ranges (no of step 7), the process is directly ended (step 9). In other words, this case is a case in which a second one of the conditions described in the control rule is not satisfied.

On the other hand, if both of the values “v2” and “v2−v1” are within the upper/lower-limit ranges (yes of step 7), a decision of action execution to change the sensing frequency from “high” to “low” is made (step 8), and the process is ended (step 9). Therefore, this case corresponds to a case in which the above described second one of the conditions described in the control rule is satisfied, and the decision to execute the action of changing the sensing frequency to “low” as the action determined in accordance with the condition is made. It is assumed that “low” is a predetermined value and is a value lower than the threshold value judged in step 4.

Hereinabove, based on the configuration shown in FIG. 1, connecting the plurality of field-specific simulators to the meta-level multi-agent simulator and carrying out simulations across the plurality of fields, dynamically changing the sensing frequency of the events in accordance with the values of the events, etc. have been shown.

Note that the meta-level multi-agent simulator and the field-specific simulators may be disposed in the same computer or may be disposed in different computers. The computer(s) may use a general personal computer(s) (PC) or may be a dedicated computer.

In the illustrated example, the environments for the simulators 1 and 2 are provided in a same apparatus as the meta-level multi-agent simulator, but may be configured to be provided in the same apparatus(es) as the field-specific simulators 1 and 2. The field-specific simulators 1 and 2 may be disposed in the same apparatus as the meta-level multi-agent simulator.

The agents may be prepared respectively for all of the simulated monitor targets, or a configuration in which the agents are prepared only for part of the simulated monitor targets is also possible. All of the agents may be integrated to constitute one agent processor. In this case, elements in the agent processor carry out the processes with respect to all the agents. For example, the event receiver of the agent processor receives the events with respect to all the agents.

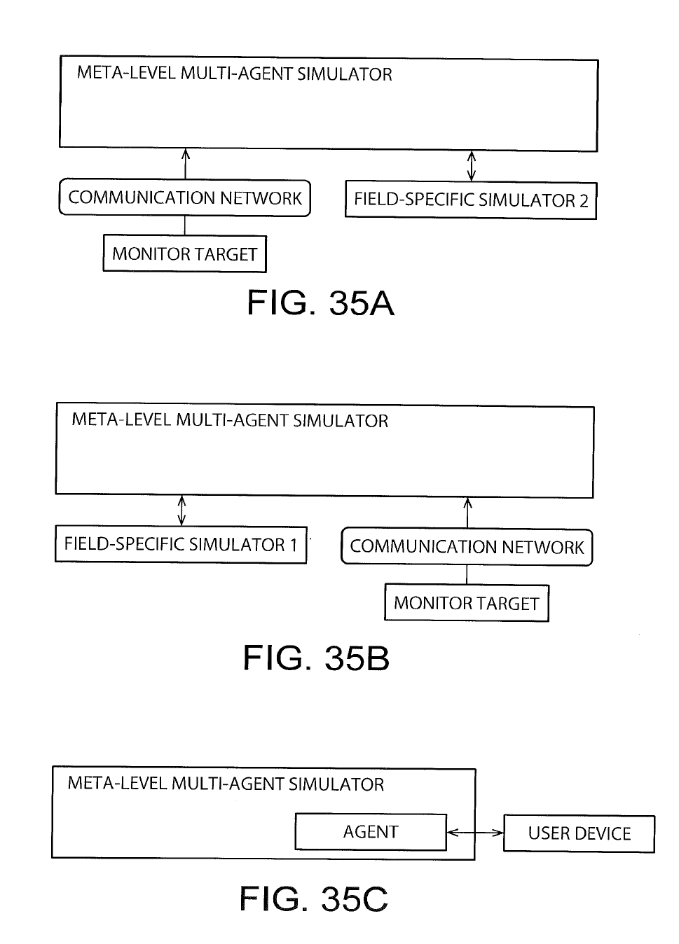

As a modification example of the present embodiment, not only the field-specific simulator but also a wired or wireless communication network is connected to the meta-level multi-agent system, and simulations across the field-specific simulator and a communication apparatus on the communication network, a user having the communication apparatus, or equipment incorporating the communication apparatus can be carried out. An example in which the field-specific simulator 1 is changed to a wired or wireless communication network is shown in FIG. 35A, and an example in which the field-specific simulator 2 is changed to a wired or wireless communication network is shown in FIG. 35B. In this case, a communication apparatus(es), user(s), or equipment on the communication network serves as a monitor target(s), and an environment for controlling the communication apparatus, etc. via the communication network can be prepared. Event detection is carried out by actually receiving data from the communication apparatuses via the network, and, as execution commands of actions, control commands can be actually transmitted to the communication apparatuses or user devices via the network. The user devices may be mobile terminals such as mobile phones or smartphones, may be stationary-type apparatuses such as TVs, personal computers, or car navigation apparatuses, or may be other devices. Completion of execution of the action may be perceived when a report of completion of the action is received from the communication apparatus. If the control command is, for example, a command which urges the user of the communication apparatus to move, completion of execution of the action may be perceived when a report of execution of the command is received from the user. When an event is to be detected from the communication apparatus, the event may be detected by input from the user. Note that the simulator time advancer 13 synchronizes the time progress of the field-specific simulator in accordance with the time progress of the communication network. If the simulation velocity of the field-specific simulator is high, such a modification example is also possible. Moreover, as another modification example, a configuration in which some of the agents of the agent group determines actions in accordance with instruction inputs of users, in other words, decisions of the users instead of determining the actions to be executed in accordance with the control rules is also possible. A configuration example of this case is shown in FIG. 35C. In this case, the decision maker of at least one agent reports the event, which has been received by the event receiver 21, to the user device via wired or wireless communication and determines the action to be executed in accordance with input of an instruction signal from the user device. The decision maker may transmit a control command to the user device based on an execution command of the action determined based on the input from the user device. The user device may be a mobile terminal such as a mobile phone or a smartphone, may be a stationary apparatus such as a TV, a personal computer, or a car navigation apparatus, or may be another device. The mode shown in FIG. 35C may be combined with the mode shown in FIG. 35A or FIG. 35B.

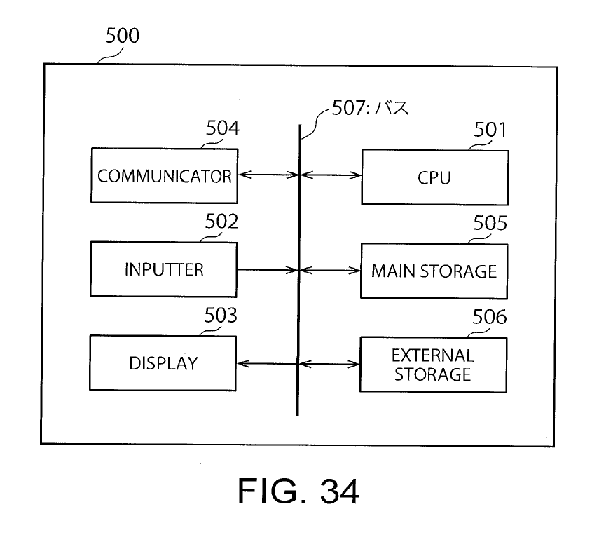

FIG. 34 shows hardware of the meta-level multi-agent simulator shown in FIG. 1. The meta-level multi-agent simulator can be realized by using a computer apparatus as basic hardware. As shown in FIG. 34, the computer apparatus is provided with a CPU 501, an inputter 502, a display 503, a communicator 504, a main storage 505, and an external storage 506, and these are mutually communicatably connected by a bus 507. The inputter 502 is provided with an input device(s) such as a keyboard, a mouse, etc. and outputs manipulation signals, which are caused by manipulations of the input device(s), to the CPU 501. The display 503 includes a display such as an LCD (Liquid Crystal Display), a CRT (Cathode Ray Tube), etc. The communicator 504 has a wireless or wired communicator and carries out communication by a predetermined communication scheme. Examples of the external storage 506 include storage media such as a hard disk, a memory apparatus, CD-R, CD-RW, DVD-RAM, or DVD-R. The external storage 506 stores a control program for causing the CPU 501 to execute the processes of the present meta-level multi-agent simulator. Moreover, data of storages (DB) provided in the present simulator is stored. Under control by the CPU 501, the main storage 505 decompresses the control program stored in the external storage 506 and stores the data necessary upon execution of the program, the data generated by execution of the program, etc. The main storage 505 includes an arbitrary memory such as a non-volatile memory. The above described control program may be realized by being installed in the computer apparatus in advance, or the program may be stored in a storage medium such as CD-ROM or distributed via the network and appropriately installed in the computer apparatus. Note that a configuration in which the inputter 502 and the display 503 are not provided is also possible. Moreover, if the field-specific simulator is the same apparatus as the present meta-level multi-agent simulator, a configuration not provided with the communicator 504 is also possible.

According to the present embodiment described above, the situation monitors which monitor the field-specific simulators can transmit events to the appropriate agents at appropriate timing, and the agents can make decisions at appropriate timing. Moreover, the agents can select and control the appropriate field-specific simulators based on the information collected across the plurality of fields. Furthermore, the agents can exhaustively monitor all the events of the field-specific simulators. As a result, simulations can be carried out across a plurality of different fields such as traffic, electric power, water and sewage, gas, heat, medical services, and education in order to design/evaluate, for example, a smart community from an individual point of view. Moreover, the time for event monitoring across them can be reduced.

Hereinafter, based on the configuration shown in FIG. 1, Examples 1 to 6 of the present invention will be explained.

### Example 1

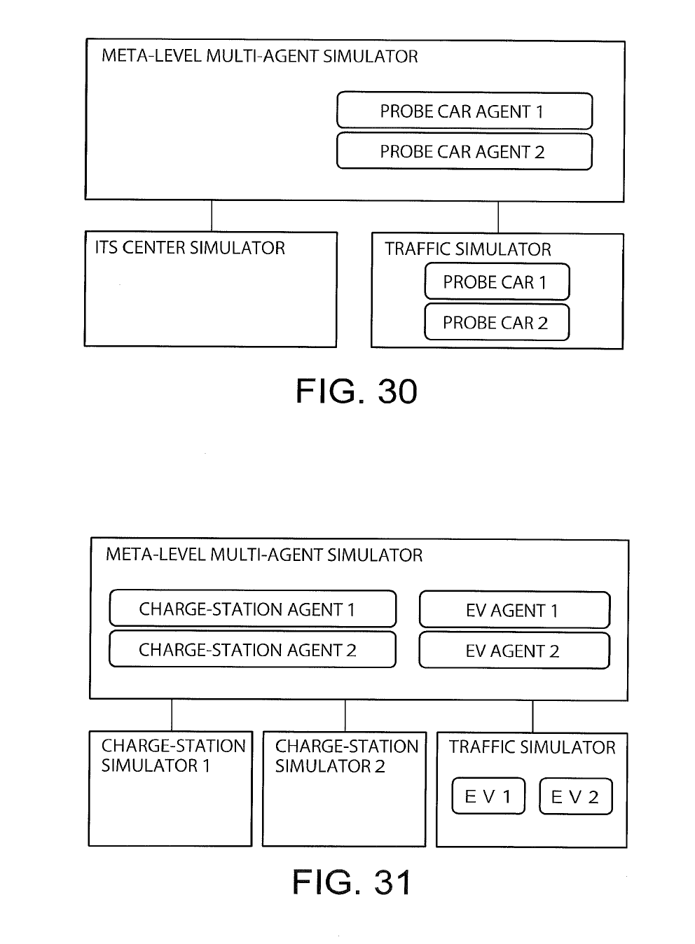

FIG. 30 shows a specific example of the field-specific simulators and agents according to Example 1.

As the two field-specific simulators, a traffic simulator and an ITS center simulator are prepared, and they are plugged into a higher-level multi-agent simulator (the meta-level multi-agent simulator of FIG. 1).

The traffic simulator simulates the movement of each one of cars at a micro level. Several driving cars in the traffic simulator are set as probe cars (in this case, probe cars 1 and 2). The ITS center simulator perceives/analyzes the traffic-jam situation of a road(s) of the traffic simulator. Probe car agents (in this case, probe car agents 1 and 2) of which number is the same to correspond to the cars driving in the traffic simulator are prepared as agents of the meta-level multi-agent simulator.

The names (identifiers) of the probe cars are expressed by “Name”. The probe car agent of “Name” is expressed as “probeCarAgent(Name)”. Also, events issued by the situation monitor 32, which monitors the traffic simulator, are expressed as “probeCarEvent(Name,X1,Y1,V1,N1). “X1,Y1” expresses the position (coordinate) of the probe car, “V1” expresses the velocity of the probe car, and “N1” expresses the number of cars around the probe car. “Around” expresses a certain range from the probe car, for example, within a radius “r”.

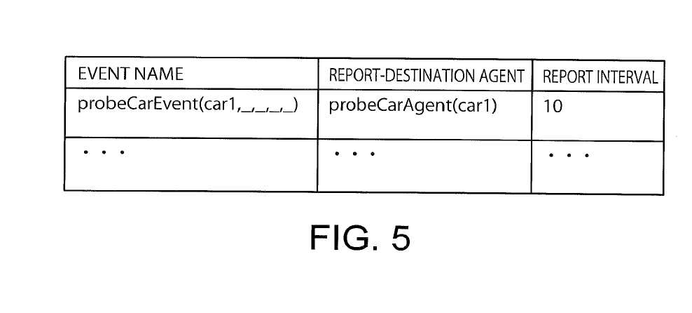

FIG. 5 shows an example of the report-interval DB 33 with respect to the probe car agents according to Example 1. The case of this example shows that the situation monitor 32 reports an event “probeCarEvent(car1,_,_,_,_)” to the probe car agent “probeCarAgent(car1)” at every 10 seconds. Herein, “_” means that arbitrary values are assignable to “X1,Y1,V1,N1”. “10 seconds” are the time in the traffic simulator.

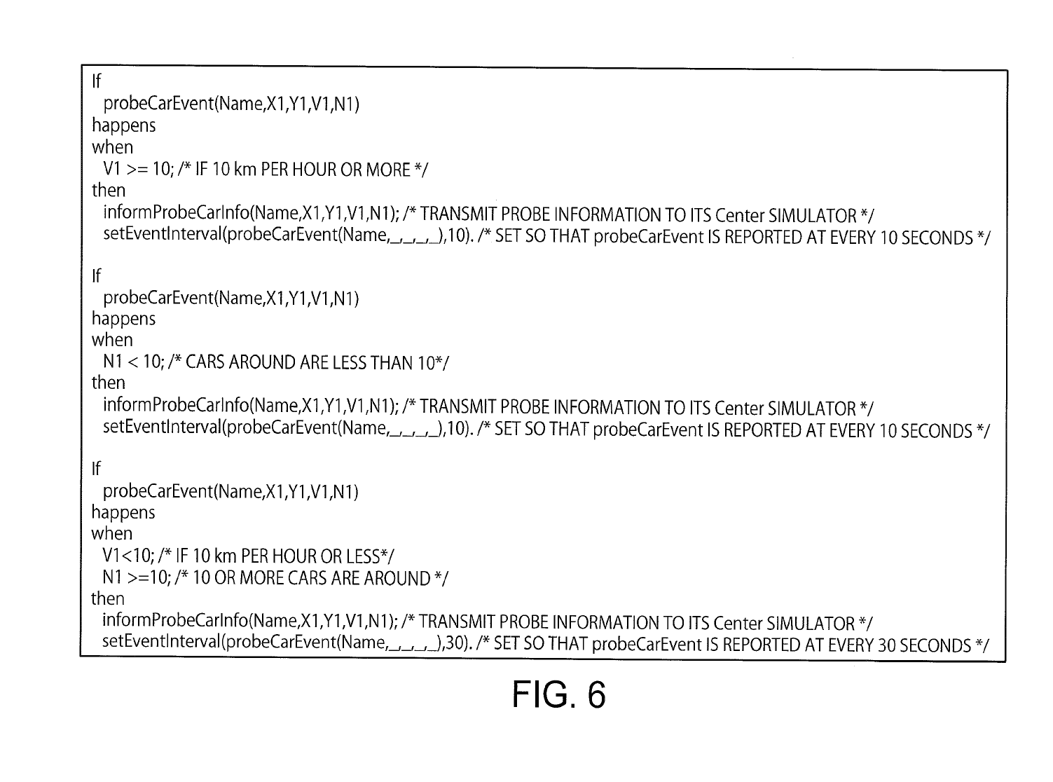

FIG. 6 shows an example of the simulator control-rule DB 20 of the probe car agents according to Example 1.

This example includes three control rules for the case in which a report of the event “probeCarEvent(Name,X1,Y1,V1,N1)” is received. All of the three control rules are expressed in the format of “if-when-then”. “If” describes an event, “when” describes a condition, and “then” describes an action. In a case in which the event described in the “If” statement is reported, if the condition described in the “when” statement is satisfied (in other words, if the control rule is fired), a decision to execute the action described in “then” is made.

The first control rule determines that, in a case in which the event of “probeCarEvent(Name,X1,Y1,V1,N1)” is reported, if a condition that the velocity “V1” is equal to or more than 10 km per hour is satisfied, two actions, i.e., “informProbeCarInfo(Name,X1,Y1,V1,N 1)” and “setEventInterval(probeCarEvent(Name,_,_,_,_),10) are to be executed. “informProbeCarInfo(Name,X1,Y1,V1,N1)” is an action of reporting the position, velocity, and the number of cars around of a corresponding probe car “Name” on the traffic simulator to the ITS center simulator. “setEventInterval(probeCarEvent(Name,_,_,_,_),10)” is a sensing-frequency adjustment action of setting the report interval of an event “probeCarEvent(Name,_,_,_,_)” to 10.

The second control rule determines that, in a case in which “probeCarEvent(Name,X1,Y1,V1,N1)” is reported, if a condition that the number “N1” of cars around is less than 10 is satisfied, two actions, i.e., “informProbeCarInfo(Name,X1,Y1,V1,N1)” and “setEventInterval(probeCarEvent(Name,_,_,_,_),10)” are to be executed.

The third control rule determines that, in a case in which an event of “probeCarEvent(Name,X1,Y1,V1,N1)” is reported, if conditions that the velocity “V1” is less than 10 km/hour and that the number “N1” of the cars around is 10 or more are satisfied, two actions, i.e., “informProbeCarInfo(Name,X1,Y1,V1,N1)” and “setEventInterval(probeCarEvent(Name,_,_,_,_),30)” are to be executed. “setEventInterval(probeCarEvent(Name,_,_,_,_),30)” is a sensing-frequency adjustment action which sets the report interval of the event “probeCarEvent(Name,_,_,_,_)” to 30.

In all of the three control rules, the probe car agent “probeCarAgent(car1)”, which has received the event report of “probeCarEvent(Name,X1,Y1,V1,N1)”, executes an action “informProbeCarInfo(car1,X1,Y1,V1,N1)” of reporting the position, the velocity, and the number of the cars around of a corresponding probe car “car 1” on the traffic simulator to the ITS center simulator.

Differences of the three control rules reside in the differences among the case of “V1>=10”, the case of “N1<10”, and the case of “V1<10” and “N1>=10” in “when”.

More specifically, in a case of “V1>=10” or “N1<10” like the first or second control rule, a decision to execute the sensing-frequency adjustment action setEventInterval(probeCarEvent(car1,_,_,_,_),10)” of setting the report interval of the event “probeCarEvent(car1,_,_,_,_)” to 10 is made. In a case of “V1<10” and “N1>=10” like the third control rule, a decision to execute a sensing-frequency adjustment action “setEventInterval(probeCarEvent(car1,_,_,_,_),30)” of setting the report interval of the event “probeCarEvent(car1,_,_,_,_)” to 30 is made.

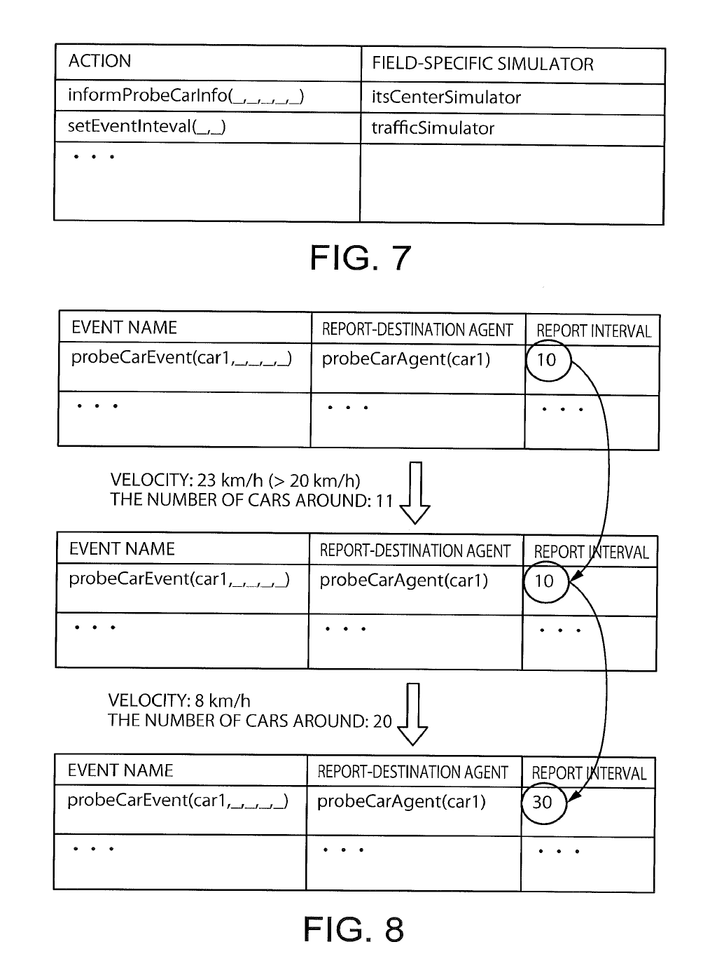

FIG. 7 shows an example of the environment reference DB 30 in the execution command transmitter 29 of the probe car agent “probeCarAgent(car1)”.

“informProbeCarInfo” is an action of controlling the ITS center simulator (itsCenterSimulator), and “setEventInterval” is an action to control the traffic simulator (trafficSimulator). Herein, only the two actions are shown; however, more actions and simulators may be registered in practice. It shows that, if the decision to execute “informProbeCarInfo” is made, the execution command transmitter 29 transmits the action to the controller 31 for the ITS center simulator (itsCenterSimulator). It shows that, if the decision to execute the action of “setEventinterval” is made, the action is transmitted to the controller 31 for the traffic simulator (trafficSimulator).

Hereinafter, operation according to Example 1 will be explained.

The situation monitor 32, which monitors the traffic simulator, recognizes the position (X1,Y1), the velocity “V1”, and the number “N1” of the cars around of each of the probe cars “Name” and reports an event “probeCarEvent(Name,X1,Y1,V1,N1)” to the corresponding probe car agent “probeCarAgent(Name)” of the meta-level multi-agent simulator at a time interval of a certain interval.

In the present example, it is assumed that the situation monitor 32 of the traffic simulator reports an event “probeCarEvent(car1,123123,12345,23,11)” to the probe car agent “probeCarAgent(car1).

The decision maker 22 of the probe car agent “probeCarAgent(car1), which has received the event report from the situation monitor 32, references the simulator control-rule DB 20 (FIG. 6). Since “V1>10 (V1=23)”, in accordance with the first control rule, a decision to execute actions “informProbeCarInfo(car1,123123,12345,23,11)” and “setEventInterval(probeCarEvent(car1,_,_,_,_),10)” is made. The execution command transmitter 29 of “probeCarAgent(car1)” references the environment reference DB 30 (FIG. 7) and transmits an execution command of the action “informProbeCarInfo(car1,123123,12345,23,11)” to the controller 31 for the ITS center simulator. The controller 31 for the ITS center simulator executes the action, thereby registering the information (i.e., the probe car “car 1” is positioned at (123123,12345), the velocity thereof is 23, and 11 cars are present therearound) described in the action into an ITS center, which is monitored by the ITS center simulator.

The execution command transmitter 29 subsequently transmits an execution command of the action “setEventInterval(probeCarEvent(car1,_,_,_,_),10)” to the controller 31 for the traffic simulator. The controller 31, which has received the execution command of the action, updates the report-interval DB 33 corresponding to the traffic simulator in accordance with the information described in the action.

FIG. 8 shows a state that the report-interval DB 33 is updated. Herein, it is updated in a manner from an upper level to an intermediate level of FIG. 8. The report interval after the update is “10”, which is the same value as the previous time. As a result, a next report of the event “probeCarEvent(car1,_,_,_,_)” to “probeCarAgent(car1)” by the situation monitor is 10 seconds thereafter.

It is assumed that, subsequently, the situation monitor 32, which monitors the traffic simulator, reports “probeCarEvent(car1,123456,12121,8,20)” to the probe car agent “probeCarAgent(car1)” in accordance with the report-interval DB 33 after 10 seconds.

At this point, the decision maker 22 of “probeCarAgent(car1)” references the simulator control-rule DB 20 (see FIG. 6) and, since “V1<10 (V1=8)” and “N1>=10 (N1=20)”, determines that the condition of the third control rule shown in FIG. 6 is satisfied. Therefore, in accordance with the third control rule, a decision to sequentially execute the actions “informProbeCarInfo(car1,123456,12121,8,20)” and “setEventInterval(probeCarEvent(car1,_,_,_,_),30)” is made.

The execution command transmitter 29 of “probeCarAgent(car1) references the environment reference DB 30 (FIG. 7) therein and transmits an execution command of the action “informProbeCarInfo(car1,123456,12121,8,20)” to the controller 31 for the ITS center simulator. The controller 31 registers the information described in the action into the ITS center simulator.

Subsequently, the execution command transmitter 29 of “probeCarAgent(car1)” transmits an execution command of the action “setEventInterval(probeCarEvent(car1,_,_,_,_),30)” to the controller 31 for the traffic simulator. The controller 31, which has received the execution command of the action, updates the report-interval DB 33 corresponding to the traffic simulator in a manner from the intermediate level to a lower level of FIG. 8. As a result, a next report of this event to “probeCarAgent(car1)” is 30 seconds thereafter.

In this manner, the frequency of reporting events to the probe car agent can be changed depending on the velocity and the number of the cars therearound. For example, in a case in which the velocity is low and the number of cars therearound is large due to a traffic jam, if there are not much changes in the information obtained by frequent probing, the report frequency can be reduced. As a result, traffic simulations can be quickly advanced.

In response to the event report from the situation monitor 32, which motors the traffic simulator, to the probe car agent, not only the execution command of the action with respect to the traffic simulator but also the execution command of the action with respect to the ITS center simulator (in the present example, the information of the action probe cars is registered in the ITS center) are carried out; therefore, simulations can be carried out across the plurality of fields (simulators). In other words, the results of the actions taken by the plurality of agents by the decisions of themselves can be comprehensively simulated across the plurality of fields.

### Example 2

As well as Example 1, as shown in FIG. 30, as two field-specific simulators, a micro-level traffic simulator and an ITS center simulator, which perceives/analyzes the traffic-jam situation of a road(s) of the traffic simulator, are prepared, and these are plugged into a meta-level multi-agent simulator. Moreover, probe car agents 1 and 2 which are corresponding to and the same in number with probe cars 1 and 2, which drive in the traffic simulator, are prepared as agents of the meta-level multi-agent simulator (see FIG. 1).

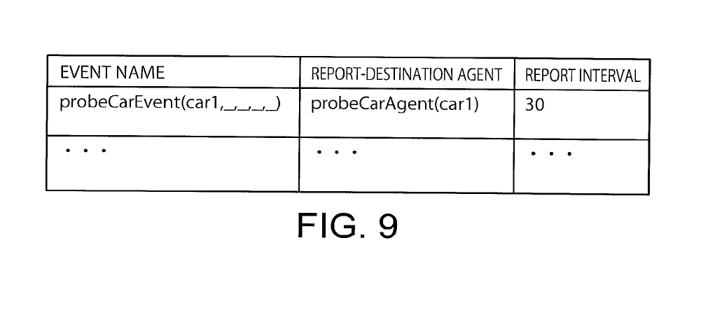

As well as Example 1, the situation monitor 32, which monitors the traffic simulator, recognizes the position (X1,Y1), velocity “V1”, and the number “N1” of cars around of each of probe cars “Name” and reports an event “probeCarEvent(Name,X1,Y1,V1,N1)” to the corresponding probe car agent “probeCarAgent(Name)” of the meta-level multi-agent simulator at the report interval registered in the report-interval DB 33. FIG. 9 shows an example of the report-interval DB 33 according to Example 2. In the case of this example, the situation monitor 32 reports an event “probeCarEvent(car1,_,_,_,_)” to the probe car agent “probeCarAgent(car1)” at every 30 seconds. Herein, “_” means that arbitrary values are assignable thereto (the same applies hereinafter).

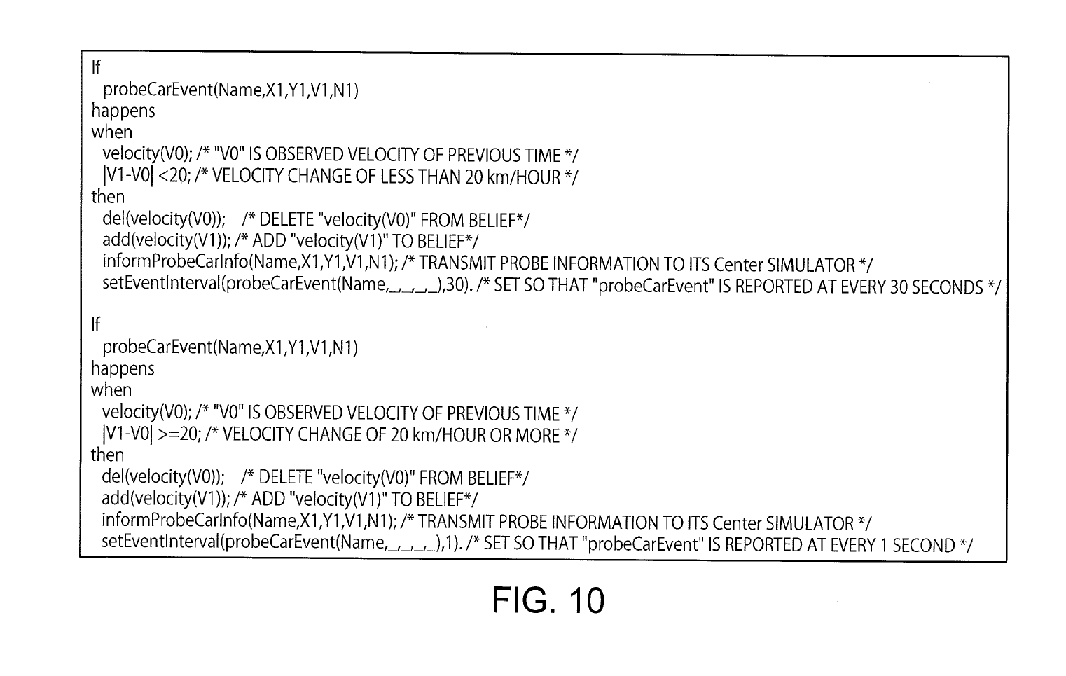

FIG. 10 shows an example of the simulator control-rule DB 20 according to Example 2. In this example, two control rules of a case in which a report of an event “probeCarEvent(Name,X1,Y1,V1,N1)” is received are determined.

In the first control rule, below things are determined. In a case in which a report of the event “probeCarEvent(Name,X1,Y1,V1,N1)” is received, if a difference absolute value of an observed velocity “velocity(V0)” of a previous time registered in the belief DB 26 and the velocity “V1” of this time satisfies a condition that it is less than 20 km/hour (|V1−V0|<20), four actions, i.e., “del(velocity(V0))”, “add(velocity(V1))”, “informProbeCarInfo(Name,X1,Y1,V1,N1)”, and “setEventInterval(probeCarEvent(car1,_,_,_,_),30)” are to be executed. “del(velocity(V0))” is an action of deleting the observed velocity “V0” of the previous time from the belief DB 26. “add(velocity(V1))” is an action of adding the observed velocity “V1” of this time to the belief DB 26. “informProbeCarInfo(Name,X1,Y1,V1,N1)” and “setEventInterval(probeCarEvent(car1,_,_,_,_),30)” are as described in Example 1.

In the second control rule, below things are determined. In a case in which a report of the event “probeCarEvent(Name,X1,Y1,V1,N1)” is received, the difference absolute value of the observed velocity “velocity(V0)” of the previous time registered in the belief DB 26 and the velocity “V1” of this time satisfies a condition that it is equal to or more than 20 km/hour (|V1−V0|>=20), four actions, i.e., “del(velocity(V0))”, “add(velocity(V1))”, “inform ProbeCarInfo(Name,X1,Y1,V1,N1)”, and “setEventInterval(probeCarEvent(car1,_,_,_,_),1)” are to be executed.

In both of the cases of the first and second control rules, the probe car agent “probeCarAgent(car1)”, which has received the event report of “probeCarEvent(car1,X1,Y1,V1,N1)” deletes “velocity(V0)” of the belief DB 26 and adds “velocity(V1)”. Moreover, execution of the action “informProbeCarInfo(car1,X1,Y1,V1,N1)” of reporting the position, the velocity, and the number of cars around of the corresponding probe car on the traffic simulator to the ITS center simulator is determined.

Differences between the two control rules are “|V1−V0|<20” in “when” of the first control rule and “|V1−V0|>=20” in “when” of the second control rule.

If “|V1−V0|<20” of the first control rule is satisfied, a decision to execute an action “setEventInterval(probeCarEvent(car1,_,_,_,_),30)” of setting the report interval (monitor cycle) of an event “probeCarEvent(car1,_,_,_,_)” to 30 is made. If “|V1−V0|>=20” of the second control rule is satisfied, a decision to execute an action “setEventInterval(probeCarEvent(car1,_,_,_,_),1)” of setting the report interval of the event “probeCarEvent(car1,_,_,_,_)” to 1 is made.

Hereinafter, operation according to Example 2 will be explained.

It is assumed that the situation monitor 32, which monitors the traffic simulator, has reported an event “probeCarEvent(car1,123123,12345,44,5)” to a probe car agent “probeCarAgent(car1)”. The decision maker 22 of the probe car agent (probeCarAgent(car1)), which has received the event report, references the simulator control-rule DB 20 (FIG. 10) and carries out operation for making a decision.

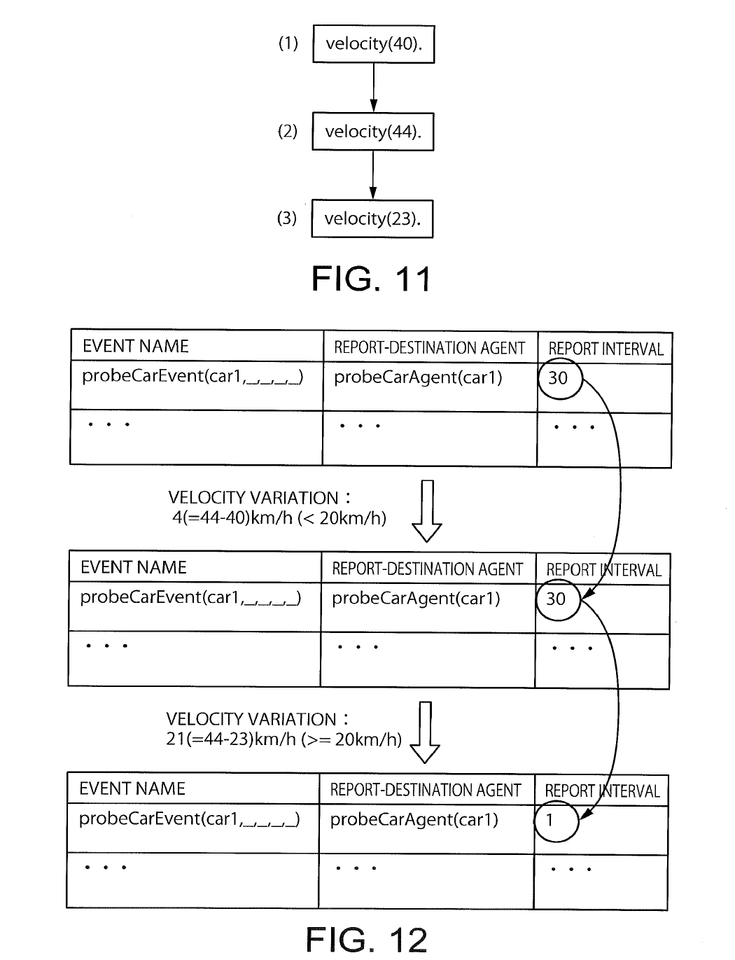

Herein, FIG. 11 shows an example of the belief DB 26 according to Example 2. It is assumed that, first, “velocity(40)” (velocity is 40 km/hour) is registered as shown in (1) of FIG. 11 as the velocity (belief) of the probe car agent “probeCarAgent(car1)”.

The decision maker 22 of “probeCarAgent(car1)” references the simulator control-rule DB 20 (FIG. 10) and the belief DB 26 and determines that “|V1−V0|<20 (V0=40, V1=44)”. Therefore, it is judged that the condition of the first control rule shown in FIG. 10 has been satisfied. Therefore, in a manner of (1) to (2) of FIG. 11, “velocity(40)” is deleted from the belief DB 26 of “probeCarAgent(car1)”, and “velocity(44)” is added thereto.

Moreover, a decision to sequentially execute actions “informProbeCarInfo(car1,123123,12345,44,5)” and “setEventInterval(probeCarEvent(car1,_,_,_,_),30)” is made.

The environment reference DB 30 of the probe car agent “probeCarAgent(car1)” is assumed to be as shown in FIG. 7 as well as Example 1. As described above, “inform ProbeCarInfo” is an action of controlling the ITS center simulator (itsCenterSimulator), and “setEventInteval” is an action of controlling the traffic simulator (trafficSimulator).

The execution command transmitter 29 of “probeCarAgent(car1)” references the environment reference DB and transmits an execution command of the action “informProbeCarInfo(car1,123123,12345,44,5)” to the controller 31 for the ITS center simulator. In accordance with the execution command of the action, the controller 31 carries out control so that the information described in the action is registered in an ITS center, which is simulated by the ITS center simulator.

Subsequently, the execution command transmitter 29 transmits an execution command of an action “setEventInterval(probeCarEvent(car1,_,_,_,_),30) to the controller 31 for the traffic simulator. In accordance with the execution command of the action, the controller 31 updates the report-interval DB 33 corresponding to the traffic simulator. The state of update of the report-interval DB 33 is shown in FIG. 12. Herein, update is carried out from an upper level to the state shown in an intermediate level of FIG. 12. As a result, a next report of this event to “probeCarAgent(car1)” is 30 seconds thereafter.

It is assumed that the situation monitor 32 of the traffic simulator has reported “probeCarEvent(car1,123456,12121,23,20)” to the probe car agent “probeCarAgent(car1)” 30 seconds thereafter in accordance with the updated report-interval DB 33.

At this point, the decision maker 22 of “probeCarAgent(car1)” references the simulator control-rule DB 20 (FIG. 10) and the belief DB 26 and, since “|V1−V0|>=20 (V0=44, V1=23)”, judges that the second control rule shown in FIG. 10 is satisfied. “velocity(44)” is deleted from the belief DB 26 of “probeCarAgent(car1)”, and “velocity(23)” is added thereto. As a result, the belief DB 26 is updated in a manner shown from (2) to (3) of FIG. 11.

Moreover, a decision to execute actions “informProbeCarInfo(car1,123456,12121,23,20)” and “setEventInterval(probeCarEvent(car1,_,_,_,_),1)” is made.

The execution command transmitter 29 of “probeCarAgent(car1)” references the environment reference DB 30 (FIG. 7) and transmits an execution command of the action “informProbeCarInfo(car1,123456,12121,23,20)” to the controller 31 for the ITS center simulator. In accordance with the execution command of the action, the controller 31 for the ITS center simulator carries out control so that the information described in the action is registered in the ITS center simulated by the ITS center simulator.

Subsequently, the execution command transmitter 29 transmits an execution command of the action “setEventInterval(probeCarEvent(car1,_,_,_,_),1)” to the controller 31 for the traffic simulator. In accordance with the execution command of the action, the controller 31 updates the report-interval DB 33 corresponding to the traffic simulator from the intermediate level of FIG. 12 to the state shown in a lower level thereof. As a result, a next report of the event to “probeCarAgent(car1)” is 1 second thereafter.

In this manner, in present Example, the report frequency of events to the probe car agent is changed depending on the velocity variation. For example, if velocity changes are small and the changes in traffic information obtained by frequent probing are small, the report frequency can be reduced. As a result, traffic simulations can be quickly advanced.

Moreover, in response to the event report from the situation monitor 32, which monitors the traffic simulator, to the probe car agent, not only the action execution commands with respect to the traffic simulator, but also action execution commands (in the present example, registration of the information of the action probe car) are carried out with respect to the ITS center simulator; therefore, simulations across the plurality of fields (simulators) are enabled. In other words, the results of actions made by the plurality of agents by the decisions of themselves can be comprehensively simulated across the plurality of fields.

### Example 3

FIG. 31 shows a specific example of field-specific simulators and agents according to Example 3.

As two types of field-specific simulators, a micro-level traffic simulator and charge-station simulators 1 and 2 are prepared. The charge-station simulators 1 and 2 calculate electric power usage amounts (or electric power consumption) of charge stations 1 and 2, respectively. These simulators are plugged into the meta-level multi-agent simulator (FIG. 1).

Moreover, EV agents corresponding to electric vehicles (EV), which drive in the traffic simulator, and charge-station agents corresponding to the charge stations are prepared as agents of the meta-level multi-agent simulator. In this case, EV agents 1 and 2 corresponding to EVs 1 and 2 and the charge-station agents 1 and 2 corresponding to the charge stations 1 and 2 are prepared.

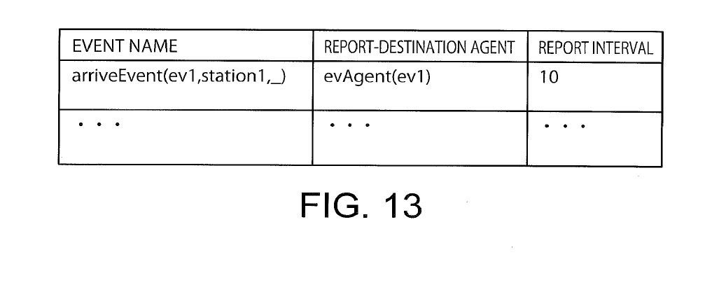

FIG. 13 shows an example of the report-interval DB 33 of the situation monitor 32, which monitors the traffic simulator, according to Example 3. In this example, “arriveEvent(ev1,station1,_)” is registered as an event, “evAgent(ev1)” is registered as a report-destination agent, and “10” is registered as a report interval.

“arriveEvent(ev1,station1,_)” is an event that, if an EV having a name “ev1” arrives at a charge station “station1”, the arrived charge station “station1” and “_” are reported to an EV agent “evAgent(ev1)” corresponding to the meta-level multi-agent simulator. In present Example, it is assumed that the value of a battery state of charge (BatteryResidue) is to be entered in “_”.

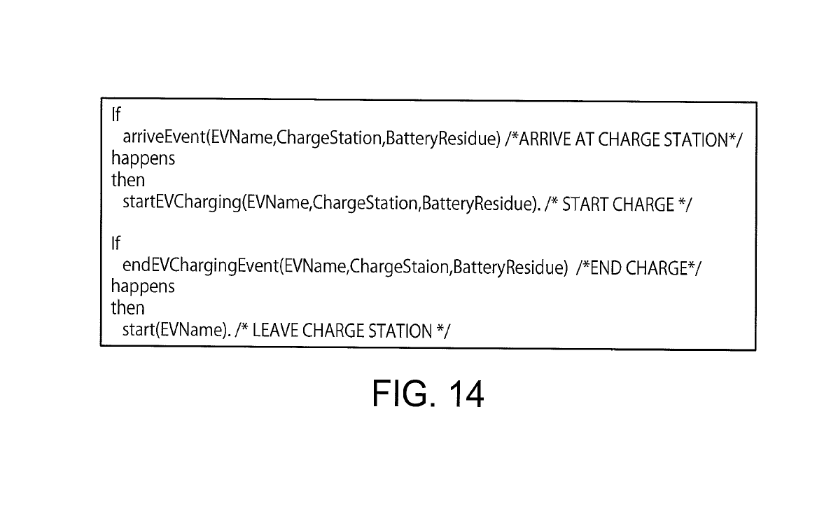

FIG. 14 shows an example of the simulator control-rule DB 20 of the EV agent according to Example 3. In this case, two control rules are defined. Both of the control rules are defined in the format of “If-then”.

The first control rule determines that, if an event “arriveEvent(EVName,ChargeStation,BatteryResidue)” is reported, a decision to execute an action of “startEVCharging(EVname,ChargeStation,BatteryResidue)” is made.

“arriveEvent(EVName,ChargeStation,BatteryResidue)” expresses that an EV (EVname) having a battery state of charge “BatteryResidue” arrived at a charge station having a charge station name “ChargeStation”. “startEVCharging(EVname,ChargeStation,BatteryResidue)” expresses an action of charging the EV (EVname) having the battery state of charge (BatteryResidue) by the charge station (ChargeStation).

The second control rule determines that, if an event of “endEVChargingEvent (EVName,ChargeStation,BatteryResidue)” is reported, a decision to execute “start(EVName)” is made. “endEVChargingEvent (EVName,ChargeStation,BatteryResidue)” is an event expressing that the EV (EVName) ends charging by the charge station (ChargeStation) and the battery state of charge at the point of end is “BatteryResidue”. “start(EVName)” expresses an action of causing the EV (EVName) to leave the charge station.

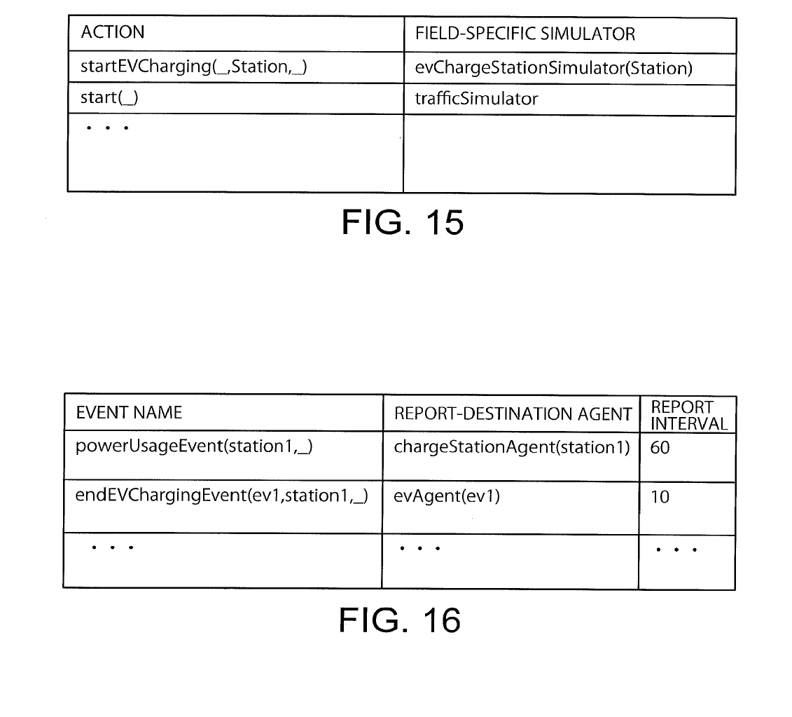

FIG. 15 shows an example of the environment reference DB 30 in the EV agent according to Example 3. An action of “startEVCharging(_,Station,_)” describes transmission to the controller 31 for the charge-station simulator (evChargeStationSimulator(Station)) corresponding to the charge station (Station). Moreover, an action “start(_)” of causing the EV to leave the charge station describes transmission to the controller 31 for the traffic simulator (trafficSimulator).

FIG. 16 shows an example of the report-interval DB 33 of the situation monitor 32, which monitors the charge-station simulator.

“powerUsageEvent(ChargeStation,Watt)” as an event name, “chargeStationAgent(ChargeStation)” as a report-destination agent, and data of a format provided with a report interval are registered in a first row.

“powerUsageEvent(ChargeStation,Watt)” is an event of calculating and reporting total electric power “Watt” used in “ChargeStation”. “chargeStationAgent(ChargeStation)” expresses the charge-station agent corresponding to the charge station (ChargeStation). The illustrated example shows that an event “powerUsageEvent(station1,_)” is transmitted to an agent of “chargeStationAgent(station1)” at every 60 seconds.

Moreover, in a second row, “endEVChargingEvent(EVName,ChargeStaion,BatteryResidue)” as an event name, “evAgent(EVName)” as a report-destination agent, and data of a format provided with a report interval are registered. “endEVChargingEvent(EVName,ChargeStaion,BatteryResidue)” is an event of reporting the battery state of charge (BatteryResidue) at the point when charge of an EV (EVName) is ended at a charge station (ChargeStation). “evAgent(EVName)” is an EV agent corresponding to “EV(EVName)”. The illustrated example shows that in a case of “EVName=ev1” and “ChargeStation=station1”, the charge situation of EV(ev1) is monitored by the simulator of the charge station (station1) at a 10-second interval, and, when charge is ended, based on the battery state of charge BatteryResidue at that point, an event “endEVChargingEvent(ev1, Staion1,_)” is reported to the agent corresponding to EV(ev1).

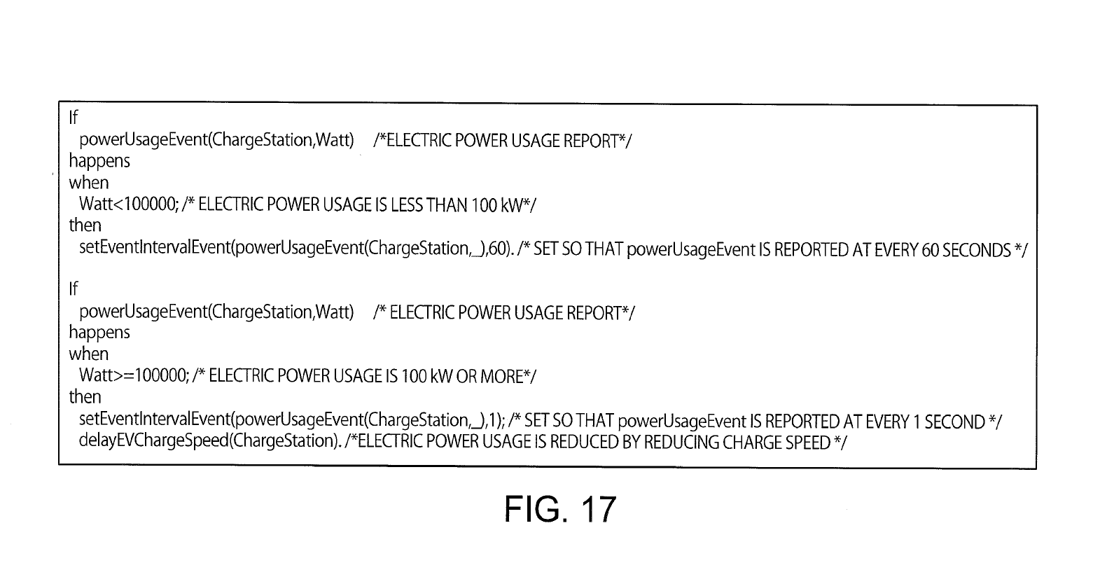

FIG. 17 shows an example of the simulator control-rule DB 20 of the charge-station agent. In this example, two control rules are defined. Each of the control rules is described in the format of “IF-when-then”.

The first control rule determines that, in a case in which an event “powerUsageEvent(ChargeStation,Watt)” is reported, if a condition of “Watt<100000” is satisfied, a decision to execute an action of “setEventIntervalEvent (powerUsageEvent(ChargeStation,_),60)” is made. “Watt<100000” means that electric power usage is less than 100 kW. “setEventIntervalEvent (powerUsageEvent(ChargeStation,_),60)” is an action to set so that “powerUsageEvent” is reported at every 60 seconds.

The second control rule determines that, in a case in which an event “powerUsageEvent(ChargeStation,Watt)” is reported, if a condition “Watt>=100000” is satisfied, a decision to execute actions “setEventIntervalEvent (powerUsageEvent(ChargeStation,_),1)” and “delayEVChargeSpeed(ChargeStation)” is made. “Watt>=100000” means that electric power usage is 100 kW or more. “setEventIntervalEvent (powerUsageEvent(ChargeStation,_),1)” is an action which sets so that “powerUsageEvent” is reported at every 1 second. “delayEVChargeSpeed(ChargeStation)” is an action which sets so that a charge speed is reduced. When the charge speed is reduced, the electric power usage can be reduced.

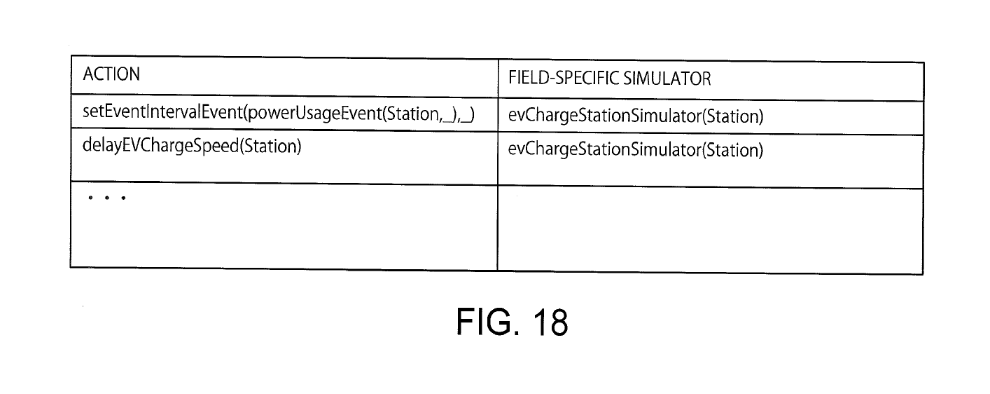

FIG. 18 shows an example of the environment reference DB 30 of the charge-station agent according to Example 3. This case shows that both actions “setEventIntervalEvent (powerUsageEvent(ChargeStation,_),_)” and “delayEVChargeSpeed(ChargeStation)” are transmitted to the controller 31 of the simulator “evChargeStationSimulator(ChargeStation)” for the charge station (ChargeStation).

Hereinafter, an example of operation according to Example 3 will be shown.

The situation monitor 32, which monitors the traffic simulator, references the report-interval DB 33 (FIG. 13), monitors the traffic simulator at a 10-second interval, and, when an EV having a name “ev1” arrives at a charge station “station1”, reports an event “arriveEvent(ev1,station1,BatteryResidue)” to the corresponding EV agent “evAgent(ev1)” of the meta-level multi-agent simulator. As a result, the arrived charge station (station1) and the battery state of charge (BatteryResidue) are reported to the EV agent “evAgent(ev1)”.

Triggered by this event, the decision maker 22 of the EV agent “evAgent(ev1)” references the simulator control-rule DB 20. When an event “arriveEvent(ev1,station1,BatteryResidue)” is received, the decision maker 22 of the EV agent “evAgent(ev1)” references the simulator control-rule DB 20 (FIG. 14) and makes a decision to execute a charge start action “startEVCharging(ev1,station1,BatteryResidue)” of the EV in accordance with the first control rule.

At this point, the execution command transmitter 29 of “evAgent(ev1)” references the environment reference DB 30 (FIG. 15) to determine a transmission destination of the action and transmits that. Specifically, the execution command transmitter transmits a charge start action “startEVCharging(ev1,station1,BatteryResidue)” to the controller for the charge station simulator “evChargeStationSimulator(station1)” of the charge station (station1). As a result, the influence of the total electric power consumption of the charge station (station1) caused by charge of the EV (ev1) can be observed by controlling the charge-station simulator of “station1”.

On the other hand, the situation monitor 32 of the charge-station simulator “evChargeStationSimulator(ChargeStation)” carries out report of an event “powerUsageEvent(station1,Watt)” in accordance with the report-interval DB 33 (FIG. 16). The decision maker 22 of the charge-station agent “chargeStationAgent(station1)”, which has received the event “powerUsageEvent(station1,Watt)”, makes a decision to execute a different action(s) depending on the amount of electric power usage “Watt” in accordance with the simulator control-rule DB 20 (FIG. 17).

In a case of “Watt<100000”, it is determined that the condition of the first control rule is satisfied. Therefore, a decision to execute an action “setEventIntervalEvent(powerUsageEvent(station1,_),60)” of setting the report interval of the electric-power usage report event to 60 seconds is made.

In a case of “Watt>=1000000”, it is determined that the condition of the second control rule is satisfied. Therefore, a decision to execute an action “setEventIntervalEvent(powerUsageEvent(station1,_),1)” of setting the report interval of the electric-power usage report event to 1 second is made. As a result, when the electric power usage is large, the electric power usage can be monitored at a high frequency. In addition, a decision to execute an action “delayEVChargeSpeed(station1)” of reducing the charge speed is made. As a result, a countermeasure against a rapid increase in the electric power usage can be taken quickly by reducing the electric power usage.

The execution command transmitter 29 references the environment reference DB 30 (FIG. 18) to determine the transmission destination(s) of the execution command(s) of the action(s) determined in accordance with the first control rule or the second control rule. In this case, for all of the actions, the controller 31 for the charge-station simulator “evChargeStationSimulator(station1)” of the charge station “station1” is determined as the transmission destination. Therefore, the execution command transmitter 29 to this transmission destination transmits the execution command(s) of the action(s) determined in accordance with the first control rule or the second control rule.

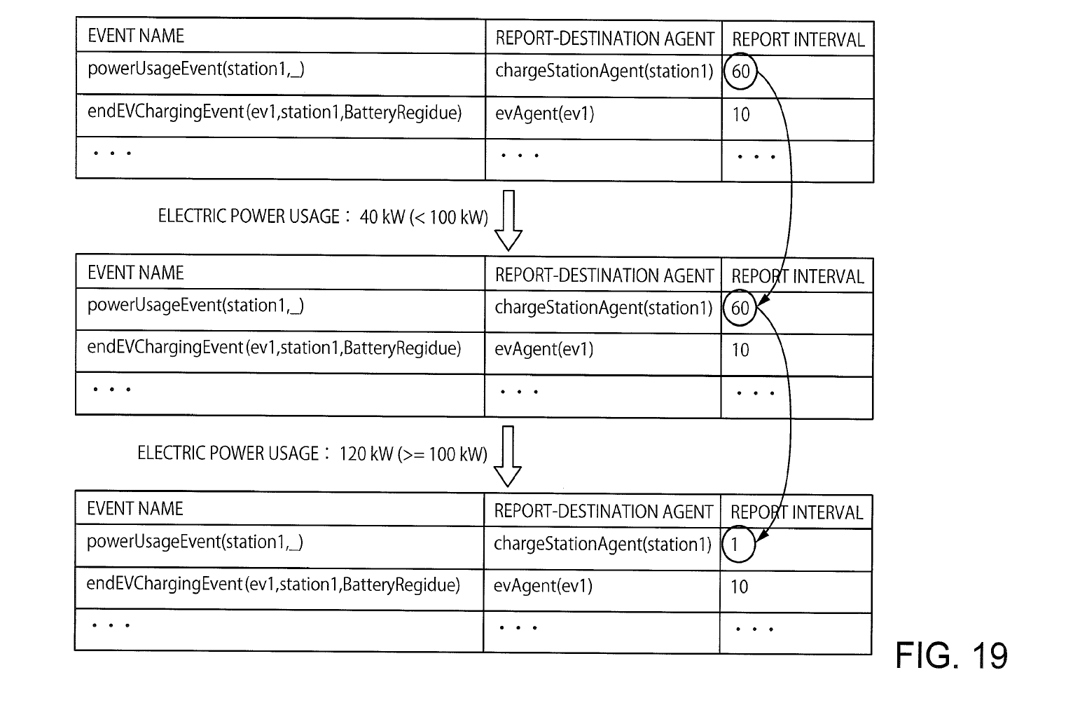

FIG. 19 shows the state of update of the report-interval DB 33 of the charge-station simulator according to Example 3. When the charge-station agent “chargeStationAgent(station1)” receives an event “powerUsageEvent(station1, 40000)”, the report interval of this event is set to 60 seconds in a manner from an upper level of FIG. 19 to an intermediate level thereof in accordance with the first control rule. Then, when an event “powerUsageEvent(station1, 120000)” is received, the report interval of this event is set to 1 second in a manner from the intermediate level of FIG. 19 to a lower level thereof, and electric power usage is reduced by reducing the charge speed of the EV (ev1) in accordance with the second control rule.

Hereinabove, according to the present Example, when the electric power usage of the charge station becomes high, the electric power usage can be reduced by reducing the charge speed, and the electric power usage of the charge station can be sensed at a high frequency.

Moreover, since the action command execution (for example, the charge station charges EV) with respect to the charge-station simulator is carried out in response to the event report (for example, arrival at the charge station) from the situation monitor 32, which monitors the traffic simulator, to the EV agent, simulations across the plurality of fields (simulators) are enabled. In other words, the results of actions carried out by the plurality of agents by the decisions of themselves can be comprehensively simulated across the plurality of fields.

### Example 4

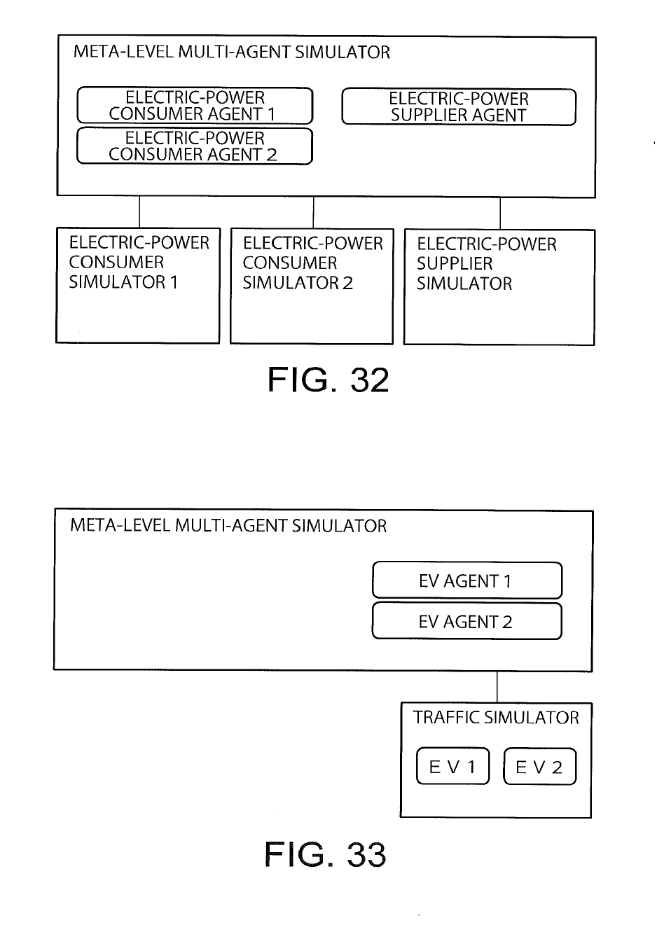

FIG. 32 shows a specific example of field-specific simulators and agents according to Example 4.

As two types of field-specific simulators, an electric-power supplier simulator and two electric-power consumer simulators 1 and 2 are prepared. These simulators are plugged into the meta-level multi-agent simulator. The electric-power supplier simulator simulates an electric-power provider(s), which adjusts the electric-power price(s) presented to electric-power consumers depending on electric-power demands. The two electric-power consumer simulators 1 and 2 simulate consumers 1 and 2, which change electric-power used amounts depending on the electric-power prices. The electric-power supplier is an example of a provider which controls electric power (product). The provider may be a provider which provides services instead of products.

The report-interval DB 33 according to Example 4 registers periodically calculating an electric-power used amount “Wh” and electric-power used time “Minutes” and reporting a electric-power usage-amount report event “powerUsageEvent(Consumer,Wh,Minutes)” to the electric-power consumer agent “powerConsumerAgent(Consumer)”. “Consumer” expresses a name of a consumer, “Wh” expresses the electric-power used amount, and “Minutes” expresses electric-power usage time.

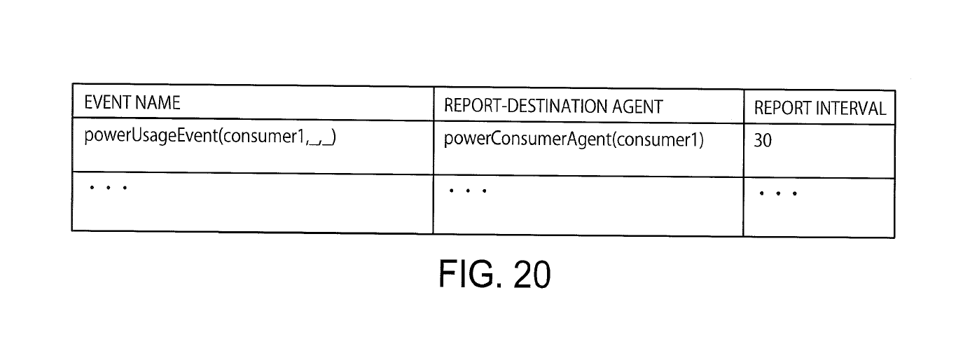

FIG. 20 shows an example of the report-interval DB 33 in the situation monitor 32 of the electric-power consumer 1. The case of this example shows that the situation monitor 32 of the electric-power consumer 1 monitors the electric-power consumer simulator 1 of “Consumer1”, calculates the electric-power used amount “Wh” and the electric-power used time “Minutes”, and reports a electric-power usage-amount report event “powerUsageEvent(Consumer1,_,_)” to the electric-power consumer agent “powerConsumerAgent(Consumer1)” at a 30-minute interval.

The decision maker 22 of the electric-power consumer agent “powerConsumerAgent(Consumer)” which has received the event “powerUsageEvent(Consumer,Wh,Minutes)” determines an action(s) to be executed in accordance with the control rules described in the simulator control-rule DB 20.

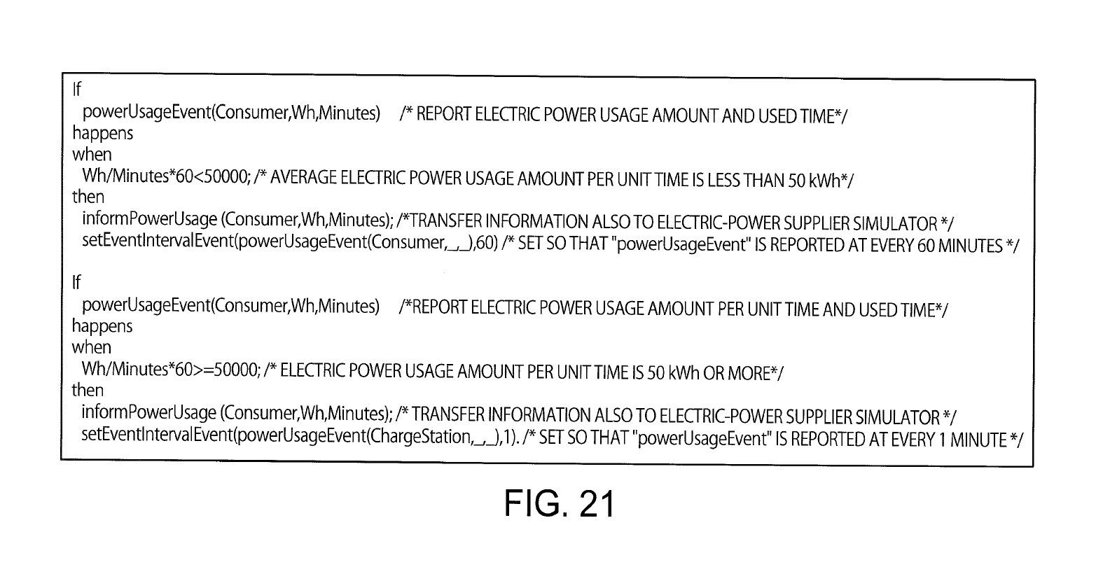

FIG. 21 shows an example of the simulator control-rule DB 20 of the electric-power consumer agent according to Example 4. In this case, two control rules are shown. Each of the control rules is described in the format of “If-when-then”.

The first control rule determines that, in a case in which “powerUsageEvent(Consumer,Wh,Minutes)” is reported, if a condition of “Wh/Minutes*60<50000” is satisfied, a decision to execute actions “informPowerUsage (Consumer,Wh,Minutes)” and “setEventIntervalEvent(powerUsageEvent(Consumer,_,_),60)” is made.

“Wh/Minutes*60<50000” means that the electric-power usage amount per unit time is less than 50 kWh. “informPowerUsage (Consumer,Wh,Minutes)” is an action of transferring information of the electric-power used amount (Wh) and the electric-power used time (Minutes) of an electric-power consumer (Consumer), and, as described later, in present Example, it is transferred from the environment reference DB 30 to the controller 31 for the electric-power consumer simulator. “setEventIntervalEvent(powerUsageEvent(Consumer,_,_),60)” is an action of setting so that “powerUsageEvent” is reported at every 60 minutes.

The second control rule determines that, in a case in which “powerUsageEvent(Consumer,Wh,Minutes)” is reported, if a condition of “Wh/Minutes*60>=50000” is satisfied, a decision to execute actions of “informPowerUsage (Consumer,Wh,Minutes)” and “setEventIntervalEvent(powerUsageEvent(Consumer,_,_),1)” is made.

“Wh/Minutes*60>=50000” means that the electric-power usage amount per unit time is equal to or more than 50 kWh. “setEventIntervalEvent(powerUsageEvent(Consumer,_,_),1)” is an action of setting so that “powerUsageEvent” is reported at every 1 minute.

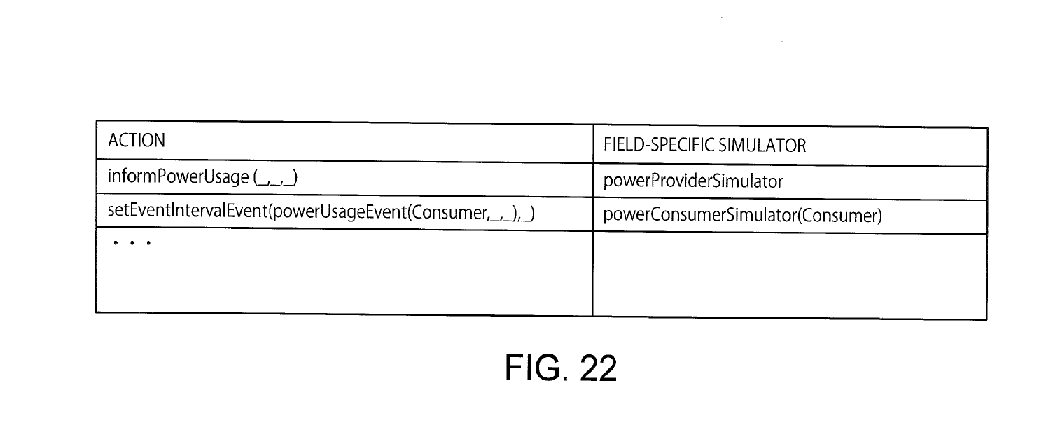

FIG. 22 shows an example of the environment reference DB 30 of the electric-power consumer agent according to Example 4. It is described that the report destination of an action “informPowerUsage(_,_,_)” is the controller for the electric-power supplier simulator (powerProviderSimulator), and the report destination of an action “setEventIntervalEvent(powereUsageEvent(consumer,_,_),_))” is the controller for the electric-power consumer simulator “powerConsumerSimulator(Consumer)” of the electric-power consumer (consumer).

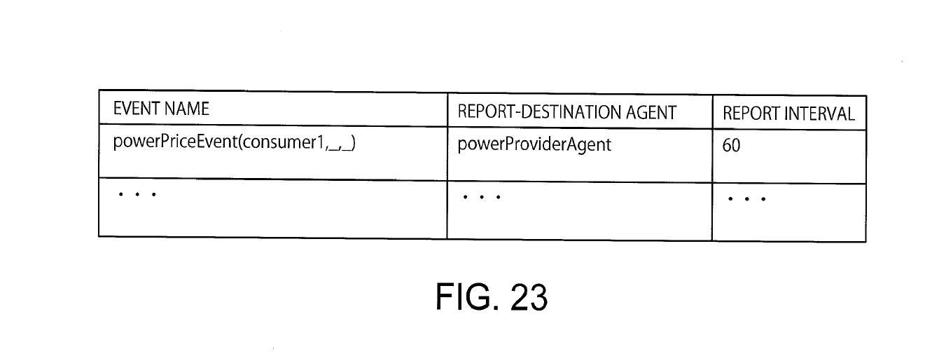

FIG. 23 shows an example of the report-interval DB 33 with respect to the electric-power supplier agent according to Example 4. This example shows an example in which an event report with respect to the consumer 1 (consumer1) is determined. It is determined that an event “powerPriceEvent(consumer1,_)” is reported to the electric-power supplier agent “powerProviderAgent” at a 60-minute interval. An arbitrary value expressing an electric-power price (Price) is to be entered in “_”.

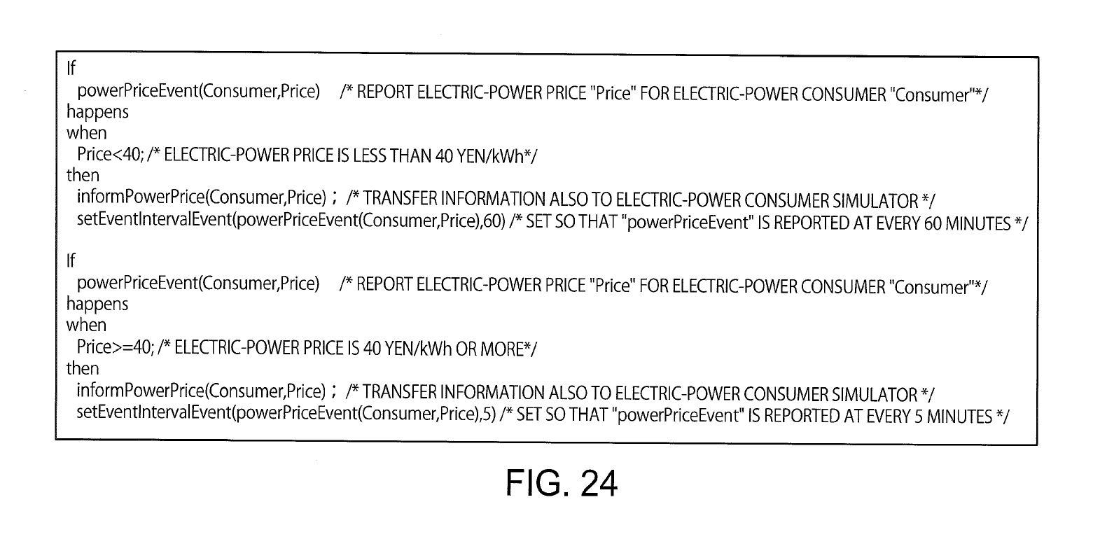

FIG. 24 shows an example of the simulator control-rule DB 20 of the electric-power supplier agent according to Example 4. In this case, two control rules are shown. Each of the control rules is described in the format of “If-when-then”.

The first control rule determines that, in a case in which an event “powerPriceEvent(Consumer,Price)” is reported, if the condition of “Price<40” is satisfied, a decision to execute actions of “informPowerPrice (Consumer,Price)” and “setEventIntervalEvent(powerPriceEvent(Consumer,Price),60)” is made. “informPowerPrice (Consumer,Price)” is an action of transferring the information of a unit electric-power price to the electric-power consumer. “setEventIntervalEvent(powerPriceEvent(Consumer,Price),60)” is an action of setting so that “powerPriceEvent” is reported at every 60 minutes.

The second control rule determines that, in a case in which “powerPriceEvent(Consumer,Price)” is reported, if a condition of “Price>=40” is satisfied, a decision to execute actions of “informPowerPrice (Consumer,Price)” and “setEventIntervalEvent(powerPriceEvent(Consumer,Price),5)” is made.

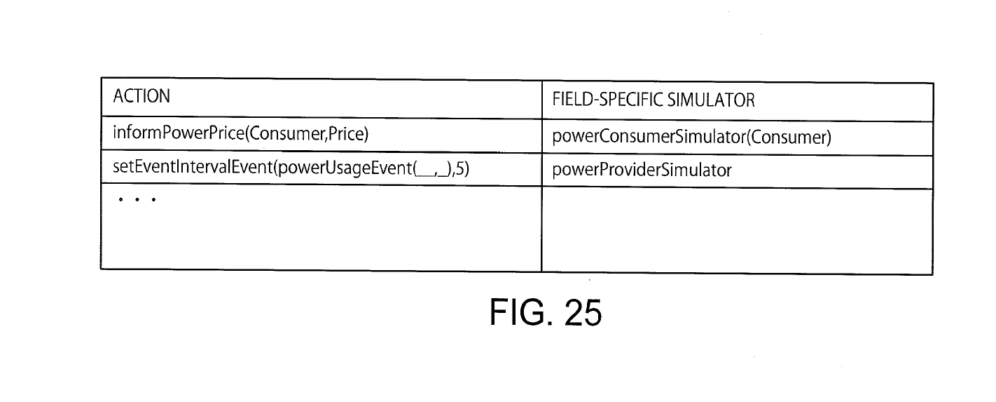

FIG. 25 shows an example of the environment reference DB 30 of the electric-power supplier agent according to Example 4. It describes that the report destination of an action “informPowerUsage(Consumer,Price)” is the controller 31, which controls the electric-power consumer simulator “(powerConsumerSimulator(Consumer))”, and the report destination of an action “setEventIntervalEvent(powereUsageEvent(_,_,_)5))” is the controller 31, which controls the electric-power supplier simulator “powerConsumerSimulator”.

Hereinafter, operation according to Example 4 will be explained.

The situation monitors 32 of the electric-power consumers monitor the situations of the electric-power consumer simulators 1 and 2, periodically generate events “powerUsageEvent(Consumer,Wh,Minutes)” and report them to the electric-power consumer agents 1 and 2 in accordance with the report-interval DB 33 (FIG. 20).

The decision maker 22 of the electric-power consumer agent “powerConsumerAgent(Consumer)”, which has received the event “powerUsageEvent(Consumer,Wh,Minutes)” references the simulator control-rule DB 20 (FIG. 21). In the case in which either one of the first control rule and the second control rule is satisfied, a decision to execute the action “informPowerUsage (Consumer,Wh,Minutes)” for transferring information also to the electric-power supplier simulator is made.

At this point, the execution command transmitter 29 of “powerConsumerAgent(Consumer)” references the environment reference DB 30 (FIG. 22) to determine the report destination of the execution command of this action. Specifically, according to the environment reference DB 30 of FIG. 22, the report destination of the action “informPowerUsage (Consumer,Wh,Minutes)” is determined to the controller 31 for the electric-power supplier simulator “powerProviderSimulator”, and it is subjected to report.

In addition, the decision maker 22 of “powerConsumerAgent(Consumer)” makes a decision to execute different actions depending on the magnitude of the electric-power usage amount “Wh” and the electric-power used time “Minutes”.

In a case of “Wh/Minutes*60<50000”, the condition of the first control rule is satisfied, and a decision to execute the action “setEventIntervalEvent(powerUsageEvent(Consumer,_,_),60)” of setting the report interval of the electric-power usage-amount report event, which is reported from the electric-power consumer simulator of the electric-power consumer “Consumer”, to 60 minutes is made.

In a case of “Wh/Minutes*60>=50000”, the condition of the second control rule is satisfied, and a decision to execute the action “setEventIntervalEvent(powerUsageEvent(Consumer,_,_),1)” of setting the report interval of the electric-power usage-amount report event, which is reported from the electric-power consumer simulator of the electric-power consumer “Consumer”, to 1 minute is made.

At this point, the execution command transmitter 29 of “powerConsumerAgent(Consumer)” references the environment reference DB (FIG. 22) to determine the report destination of the execution command of the action to the controller 31 for the electric-power consumer simulator “powerConsumerSimulator(Consumer)” of the electric-power consumer “Consumer”, and carries out transmission. As a result, if the electric-power usage amount is large, the used electric-power usage amount of the electric-power consumer can be monitored at a high frequency, and the used electric-power usage amount can be transmitted to the electric-power supplier at a high frequency.

On the other hand, the situation monitor 32 of the electric-power supplier references the report-interval DB 33 (FIG. 23) and carries out an event report. The report-interval DB 33 determines that the event “powerPriceEvent(consumer,Price)” is reported to the electric-power supplier agent “powerProviderAgent” at a certain interval. In accordance with the contents of the report-interval DB 33, the situation monitor 32 reports the event “powerPriceEvent(consumer,Price)” to the electric-power supplier agent “powerProviderAgent” at the certain interval. The decision maker 22 of the electric-power supplier agent “powerProviderAgent”, which has received the event “powerPriceEvent(consumer,Price)”, determines the actions to be executed based on the simulator control-rule DB 20 (FIG. 24).

The decision maker 22 of the electric-power supplier agent “powerProviderAgent”, which has received the event “powerPriceEvent(Consumer,Price)”, makes a decision to execute the action “informPowerPrice(Consumer,Price)” in the case in which either one of the first control rule and the second control rule is satisfied. At this point, the execution command transmitter 29 of “powerProviderAgent” references the environment reference DB 30 (FIG. 25) to determine the report destination of the execution command of the action.

The execution command transmitter 29 of “powerProviderAgent” determines the report destination of the action “informPowerPrice (Consumer,Price)” to the controller 31 for the electric-power consumer simulator “powerConsumerSimulator(Consumer)” according to the environment reference DB 30 of FIG. 25 and carries out the report. As a result, electric-power price information can be transmitted to the electric-power consumer simulator.

In addition, the decision maker 22 of “powerProviderAgent” makes a decision to execute different actions depending on the magnitude of the unit electric-power price “Price”.

In a case of “Price<40”, the condition of the first control rule is satisfied, and a decision to execute the action “setEventIntervalEvent(powerPriceEvent(Consumer,Price),60)” of setting the report interval of the unit-electric-power-price report event, which is reported from the electric-power supplier simulator, to 60 minutes is made.

In a case of “Price>=40”, the condition of the second control rule is satisfied, and a decision to execute the action “setEventIntervalEvent(powerPriceEvent(Consumer,Price),5)” of setting the report interval of the unit-electric-power-price report event, which is reported from the electric-power supplier simulator of the electric-power consumer “Consumer”, to 5 minutes is made.

At this point, the execution command transmitter 29 of “powerProviderAgent” references the environment reference DB (FIG. 25) to determine the report destination of the execution command of the action to the controller 31 for the electric-power supplier simulator “powerProviderSimulator” and carries out transmission.

As a result, when the electric-power usage amount is large, the electric-power usage amount of the electric-power consumer can be monitored at a high frequency, and the electric-power usage amount can be transmitted to the electric-power supplier at a high frequency. Moreover, when the unit electric-power price is high, the unit electric-power price can be monitored at a high frequency, and it can be transmitted to the electric-power consumer simulator.

### Example 5

FIG. 33 shows a specific example of a field-specific simulator and agents according to Example 5.

As the field-specific simulator, a micro-level traffic simulator is prepared and is plugged into the meta-level multi-agent simulator (FIG. 1). Moreover, EV agents which are corresponding to electric vehicles (EV), which drive in the traffic simulator, and are the same number therewith are prepared as agents of the meta-level multi-agent simulator. In this case, corresponding to the two EV 1 and EV 2, two EV agents 1 and 2 are prepared.

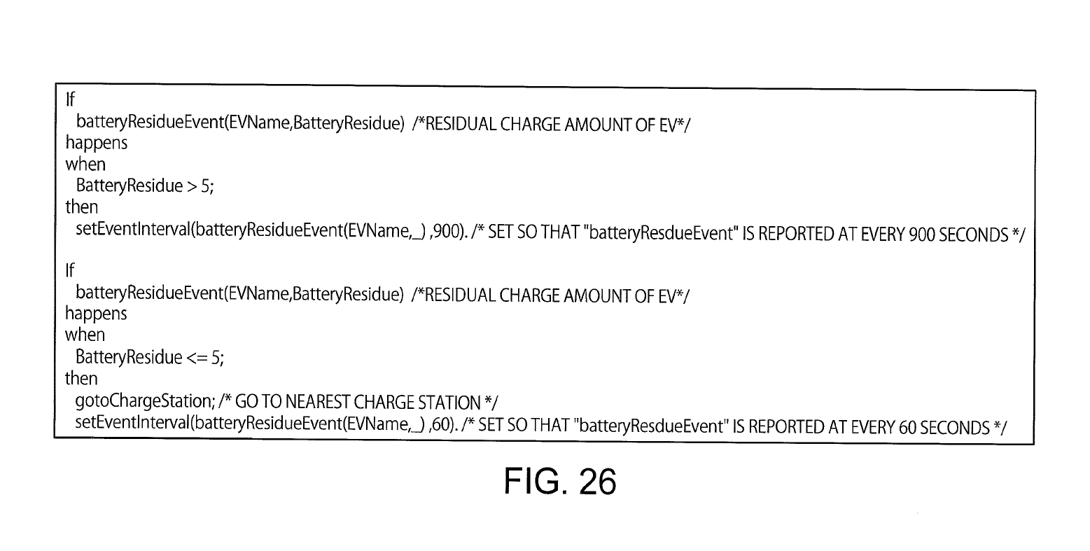

FIG. 26 shows an example of the simulator control-rule DB 20 of each of the EV agents corresponding to the EVs of the traffic simulator. The name of EV is described as “EVName”, and the EV agent corresponding to the EV having a name “EVname” is described as “evAgent(EVName)”. In this case, two control rules are defined.

In the first control rule, below things are determined. Specifically, in a case in which an event “batteryResidueEvent(EVName,BatteryResidue) is reported from the traffic simulator, if a condition that a battery state of charge “BatteryResidue” is larger than a certain value (5 kwh), a decision to execute an action “setEventInterval(batteryResidueEvent(EVname,_),900)” is made. “setEventInterval(batteryResidueEvent(EVname,_),900)” is an action of reporting the battery state of charge “BatteryResidue” to the EV agent corresponding to the EV at every 900 seconds.

In the second control rule, below things are determined. Specifically, in a case in which the event “batteryResidueEvent(EVName,BatteryResidue)” is reported from the traffic simulator, the battery state of charge “BatteryResidue” is equal to or less than a certain value (5 kwh), a decision to execute actions “gotoChargeStation” and “setEventInterval(batteryResidueEvent(EVname,_),60)” is made. “gotoChargeStation” is an action of causing the EV to go to a nearest charge station. “setEventInterval(batteryResidueEvent(EVname,_),60)” is an action of reporting the battery state of charge “BatteryResidue” to the EV agent corresponding to the EV at every 60 seconds.

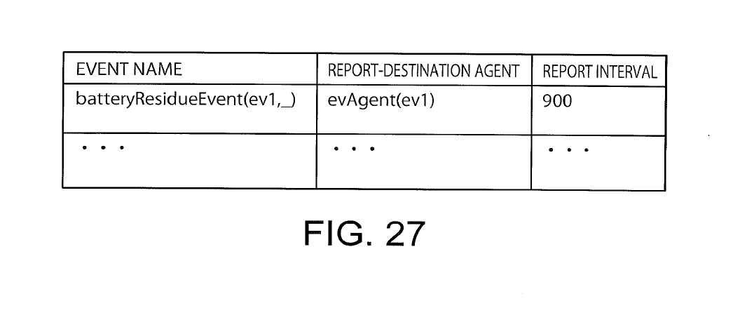

FIG. 27 shows an example of the report-interval DB 33 of the EV agent according to Example 5. It shows that the battery state of charge of each EV (in this case, “ev1”) is reported to the corresponding EV agent of the meta-level multi-agent simulator at a report interval (time interval of 900 seconds).

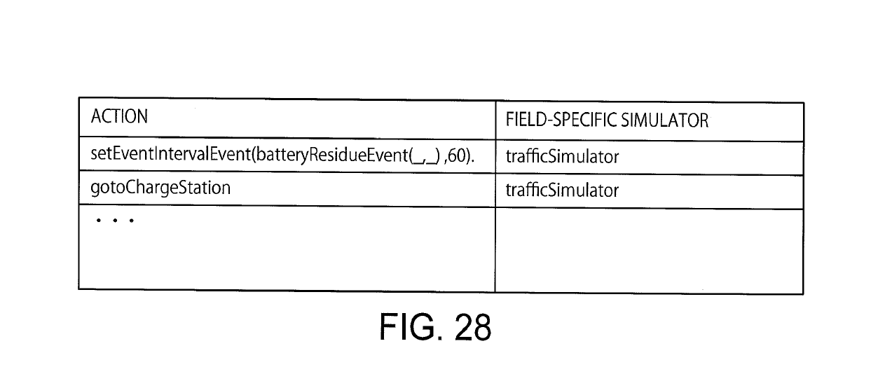

FIG. 28 shows an example of the environment reference DB 30 of the EV agent according to Example 5. It shows that “setEventInterval(batteryResidueEvent(_,_),60)” is reported to the controller for the traffic simulator. Moreover, it shows that “gotoChargeStation” is reported to the controller for the traffic simulator. Actions other than those shown in the drawing may be registered. For example, an action “setEventInterval(batteryResidueEvent(EVname,_),900)”, etc. may be registered.

Hereinafter, an example of operation according to Example 5 will be shown.

The situation monitor 32 of the traffic simulator reports an event of reporting the battery state of charge of each EV (in this case, assumed to be “ev1”) to the corresponding EV agent of the meta-level multi-agent simulator at a report interval described in the report-interval DB 33 (time interval of 900 seconds in the case of FIG. 27).

If the event report interval is too long, decision making of the EV agent may be delayed, and electricity runout may occur before arriving at a nearest charge station. Therefore, if the battery state of charge becomes a certain value or less (5 kwh) like the second control rule shown in FIG. 26, a decision to execute an action of setting a lower frequency (60 seconds) event report than a normal one (900 seconds) is made.

For example, it is assumed that the EV agent “evAgent(ev1)” of the meta-level multi-agent simulator receives an event “batteryResidueEvent(ev1,6)” that the battery state of charge of the EV (ev1) on the traffic simulator has become “6” from the situation monitor 32, which monitors the traffic simulator.

At this point, the decision maker 22 of the EV agent “evAgent(ev1)” makes a decision to execute an action “setEventInterval(batteryResidueEvent(ev1,_),900)” of setting the report frequency of the event to 900 seconds in accordance with the first control rule described in the simulator control-rule DB 20 (FIG. 26).

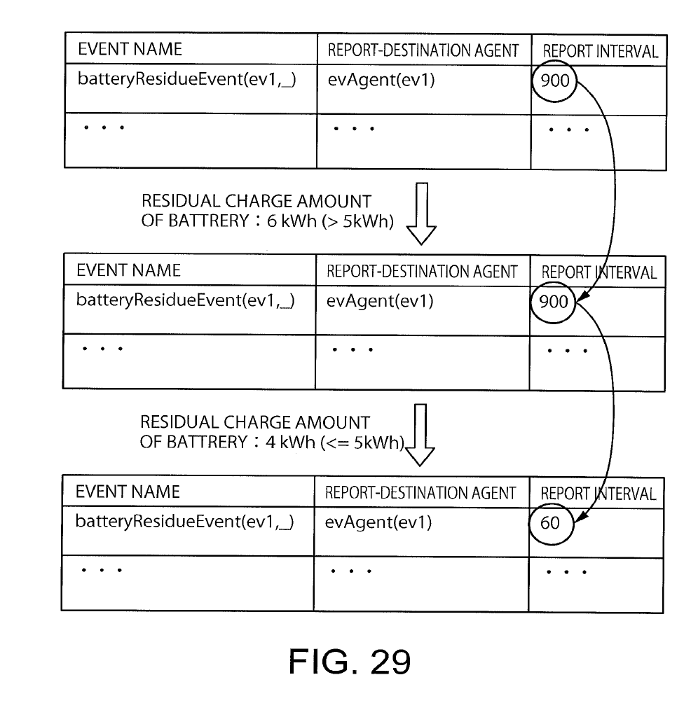

At this point, the execution command transmitter 29 of the EV agent “evAgent(ev1)” references the environment reference DB 30 (FIG. 28) and transmits an execution command of the action to the controller 31 for the traffic simulator (trafficSimulator). As shown in an upper level to an intermediate level of FIG. 29, the controller 31 sets the interval of report to the EV agent “evAgent(ev1)” in the report-interval DB 33 to 900 seconds.

After 900 seconds, it is assumed that the situation monitor 32, which monitors the traffic simulator, references the report-interval DB 33 (intermediate level of FIG. 29) and reports an event “batteryResidueEvent(ev1,4)” that the battery state of charge of the EV (ev1) on the traffic simulator has become “4” to the EV agent “evAgent(ev1)” of the meta-level multi-agent simulator.

At this point, the decision maker 22 of the EV agent “evAgent(ev1)”, first, makes a decision to execute an action “gotoChargeStation” of going to a nearest charge station in accordance with the second control rule described in the simulator control-rule DB 20 (FIG. 26).

At this point, the execution command transmitter 29 of the EV agent “evAgent(ev1)” references the environment reference DB 30 (FIG. 28) and transmits the execution command of the action to the controller 31 for the traffic simulator (trafficSimulator). As a result, the traffic simulator is controlled.

Subsequently, the decision maker 22 of the EV agent “evAgent(ev1)” makes a decision to execute the action “setEventIntervalEvent(batteryResidueEvent(ev1,_),60)” of setting the report interval of the event to 60 seconds in accordance with the above described second control rule.

At this point, the execution command transmitter 29 of the EV agent “evAgent(ev1)” references the environment reference DB 30 (FIG. 28) and transmits the execution command of the action to the controller 31 for the traffic simulator (trafficSimulator). The controller 31 sets the report interval of the event to the EV agent “evAgent(ev1)” described in the report-interval DB 33 to 60 seconds in the manner of the lower level of FIG. 29.

The next report of this event to “evAgent(ev1)” by the situation monitor 32, which monitors the traffic simulator, in accordance with the report-interval DB 33 is 60 seconds thereafter.

Hereinabove, according to present Example, when the battery state of charge of the EV becomes low, electricity runout can be prevented by sensing the battery state of charge of the EV of the traffic simulator at a high frequency.

### Example 6

In Examples 1 to 5, the report intervals of the events to the agents are set in the report-interval DB 33. However, acquisition intervals of events may be described in the belief DB 26 of the agents. In this configuration, the agent can dynamically execute an action of acquiring the event at the interval described in the belief DB 26.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A simulation apparatus comprising:
an event receiver receiving an event showing a situation of a first monitor target simulated by a first simulator simulating at least one of motion and state change of the first monitor target from a monitor apparatus monitoring a simulation of the first simulator;
a decision maker determining an action based on the event, the action to be carried out with respect to a second monitor target undergoing a simulation of at least one of motion and state change by a second simulator synchronized with the first simulator by time progress; and
an execution command transmitter transmitting an execution command of the action determined by the decision maker to a control apparatus controlling the second simulator.

2. The simulation apparatus according to claim 1, wherein
the decision maker determines, based on at least one of a type of the event and a value of the event, the action to change an acquisition frequency of the event about the first monitor target; and
the execution command transmitter transmits an execution command of the action determined by the decision maker to a control apparatus controlling the first simulator.

3. The simulation apparatus according to claim 2, wherein
based on the value of the event and a value of an event received before the event by the event receiver, the decision maker determines the action to change the acquisition frequency of the event about the first monitor target.

4. The simulation apparatus according to claim 1, wherein
the first simulator simulates at least one of the motion and state change of the plurality of first monitor targets;
an agent including the event receiver, the decision maker, and the execution command transmitter is provided for each of the first monitor targets; and
the agent receives the event showing the situation of the first monitor target corresponding to the agent from the monitor apparatus.

5. The simulation apparatus according to claim 4, wherein
the decision maker has a plurality of control rules determining types of events, conditions based on values of the events, and actions to be executed, selects the control rule matching a type of the received event and satisfying the condition from among the plurality of control rules, and determines the action shown in the selected control rule.

6. The simulation apparatus according to claim 4, wherein
the decision maker of at least one of the agents reports the event to a user device via wired or wireless communication and determines the action to be executed in accordance with an input of an instruction signal from the user.

7. The simulation apparatus according to claim 6, wherein
the execution command transmitter transmits a control command to the user device based on the execution command.

8. The simulation apparatus according to claim 1, further comprising:
a simulation controller synchronizing the time progress of the first and second simulators by transmitting an instruction signal to advance the simulations of the first simulator and the second simulator by certain time to the control apparatuses controlling the first and second simulators, respectively, and, when both of the first and second simulators are advanced by the certain time, repeatedly transmitting the next instruction signal to advance the certain time.

9. The simulation apparatus according to claim 2, further comprising:
the monitor apparatus, a first control apparatus controlling the first simulator, and a second control apparatus controlling the second simulator; wherein
the first control apparatus transmits an instruction signal to the monitor apparatus, the instruction signal to acquire an event about the first monitor target at an acquisition frequency in accordance with the execution command of the action;
the monitor apparatus acquires the event in accordance with the acquisition frequency shown by the instruction signal and transmits the event to the event receiver; and
the second control apparatus controls at least one of motion and state of the second monitor target in accordance with the execution command of the action.

10. The simulation apparatus according to claim 1, further comprising a trigger event reporter periodically generating a trigger event about the second simulator; wherein
the event receiver receives the trigger event generated by the trigger event reporter;
the decision maker determines execution of the action about the second monitor target in accordance with the number of times of reception of the trigger event by the event receiver; and
the execution command transmitter transmits the execution command of the action to the control apparatus controlling the second simulator.

11. The simulation apparatus according to claim 1, further comprising:
a trigger event reporter periodically generating a trigger event about the first simulator; wherein
the event receiver receives the trigger event generated by the trigger event reporter;
the decision maker makes a decision to acquire an event about the first monitor target in accordance with the number of reception of the trigger event by the event receiver; and
the execution command transmitter transmits an execution command of an action to acquire the event to the control apparatus controlling the first simulator.

12. The simulation apparatus according to claim 1, wherein
the event receiver receives an event from a monitor apparatus monitoring a simulation of the second simulator, the event showing a situation of the second monitor target simulated by the second simulator;
based on the event received by the event receiver, the decision maker determines an action to be carried out with respect to the first monitor target simulated by the first simulator; and
the execution command transmitter transmits an execution command of an action determined by the decision maker to a control apparatus controlling the first simulator.

13. The simulation apparatus according to claim 1, wherein
the first monitor target is a vehicle; and
a value of the event expresses at least one of a velocity of the vehicle, a position of the vehicle, and the number of another vehicle(s) present around the vehicle.

14. The simulation apparatus according to claim 1, wherein
the first monitor target is an apparatus consuming electric power; and
a value of the event expresses at least one of a voltage, a current, electric power, and an electric power usage amount of the apparatus consuming the electric power.

15. The simulation apparatus according to claim 1, wherein
the first monitor target is a vehicle moving by using energy; and
a value of the event expresses an energy remaining amount of the vehicle.

16. The simulation apparatus according to claim 1, wherein
the first monitor target is a provider of a product or a service; and
a value of the event expresses a price of the product or the service provided by the provider.

17. The simulation apparatus according to claim 1, further comprising:
a communicator connected to the first monitor target and communicatable with a wired or wireless network; wherein
the monitor apparatus monitors at least one of the motion and state change of the first monitor target of the network by using the communicator instead of the first monitor target simulated by the first simulator;
the event receiver receives an event showing a situation of the first monitor target of the network from the monitor apparatus;
based on the event received by the event receiver, the decision maker determines the action with respect to the second monitor target simulated by the second simulator undergoing synchronization of time progress with the network; and
the execution command transmitter transmits an execution command of the action determined by the decision maker to the control apparatus controlling the second simulator.

18. The simulation apparatus according to claim 1, further comprising:
a communicator connected to the second target and communicatable with a wired or wireless network; wherein
the first simulator is undergoing synchronization of time progress with the network;
the decision maker determines an action to be carried out with respect to the second monitor target connected to the network instead of the second monitor target simulated by the second simulator; and
the execution command transmitter transmits an execution command of the action determined by the decision maker to the second monitor target connected to the network via the communicator.

19. A simulation method performed by a computer, comprising:
receiving an event showing a situation of a first monitor target simulated by a first simulator simulating at least one of motion and state change of the first monitor target from a monitor apparatus monitoring a simulation of the first simulator;
determining an action based on the event, the action to be carried out with respect to a second monitor target undergoing a simulation of at least one of motion and state change by a second simulator synchronized with the first simulator by time progress; and
transmitting an execution command of the action to a control apparatus controlling the second simulator.

20. A non-transitory computer readable medium having instructions stored therein which, when executed by a computer, cause a computer to perform operations comprising:
receiving an event showing a situation of a first monitor target simulated by a first simulator simulating at least one of motion and state change of the first monitor target from a monitor apparatus monitoring a simulation of the first simulator;
determining an action based on the event, the action to be carried out with respect to a second monitor target undergoing a simulation of at least one of motion and state change by a second simulator synchronized with the first simulator by time progress; and
transmitting an execution command of the action to a control apparatus controlling the second simulator.
